(19) United States
(12) Patent Application Publication
(10) Pub. No.: US 2026/0212605 A1
(43) Pub. Date: Jul. 23, 2026

(54) BLOCK-BASED THREE-DIMENSIONAL (3D) RECONSTRUCTION SYSTEM WITH MESH HYSTERESIS AND SIMPLIFICATION

(71) Applicant: QUALCOMM Incorporated, San Diego, CA (US)

(72) Inventors: Adithya Reddy NALLABOLU, San Diego, CA (US); Pirazh KHORRAMSHAHI, San Diego, CA (US); Upal MAHBUB, El Cajon, CA (US); Mehul ARORA, San Diego, CA (US); Gokce DANE, San Diego, CA (US)

(21) Appl. No.: 19/034,455

(22) Filed: Jan. 22, 2025

(51) Int. Cl. G06T 17/20; G06T 7/73

(52) U.S. Cl. CPC G06T 17/205; G06T 7/75

(57) ABSTRACT

Systems and techniques are described for three-dimensional (3D) reconstruction of a scene. For example, a computing device can select a plurality of voxel blocks for the scene based on depth data and pose data indicative of a perspective of the depth data. The computing device can generate, based on the depth data and/or the pose data, a respective 3D representation value for each voxel block of the plurality of voxel blocks. The computing device can compare each of the respective 3D representation values with a corresponding respective previous 3D representation value to estimate a distance difference for each voxel block and can identify one or more voxel blocks that have a distance difference greater than a distance threshold. The computing device can generate a 3D mesh based on the identified one or more voxel blocks and can generate a simplified 3D mesh based on the generated 3D mesh.

### FIELD

The present disclosure generally relates to image processing. For example, aspects of the present disclosure relate to efficient block-based three-dimensional (3D) reconstruction system with mesh hysteresis and simplification.

### BACKGROUND

The increasing versatility of digital camera products has allowed digital cameras to be integrated into a wide array of devices and has expanded their use to different applications. For example, phones, drones, cars, computers, televisions, and many other devices today are often equipped with camera devices. The camera devices allow users to capture images and/or video (e.g., including frames of images) from any system equipped with a camera device. The images and/or videos can be captured for recreational use, professional photography, surveillance, and automation, among other applications. Moreover, camera devices are increasingly equipped with specific functionalities for modifying images or creating artistic effects on the images. For example, many camera devices are equipped with image processing capabilities for generating different effects on captured images.

Traditional systems for constructing 3D models use a significant amount of computational resources, memory, and bandwidth, and in some cases generate significant heat in the process. In recent decades, there has been a demand for 3D content for computer graphics, virtual reality, and communications. Recent decades have also shown a demand for performing more computing tasks on portable computing devices rather than bulky stationary computing systems.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for three-dimensional (3D) reconstruction of a scene. In some aspects, an apparatus for 3D reconstruction of a scene is provided. The apparatus includes at least one memory and at least one processor coupled to the at least one memory and configured to: select a plurality of voxel blocks for the scene based on depth data and pose data indicative of a perspective of the depth data; generate, based on at least one of the depth data or the pose data, a respective 3D representation value for each voxel block of the plurality of voxel blocks; compare each of the respective 3D representation values with a corresponding respective previous 3D representation value to estimate a distance difference for each voxel block of the plurality of voxel blocks; identify one or more voxel blocks of the plurality of voxel blocks having a distance difference greater than a distance threshold; generate a 3D mesh based on the identified one or more voxel blocks; and generate a simplified 3D mesh based on the generated 3D mesh.

In some aspects, a method for 3D reconstruction of a scene is provided. The method including: selecting a plurality of voxel blocks for the scene based on depth data and pose data indicative of a perspective of the depth data; generating, based on at least one of the depth data or the pose data, a respective 3D representation value for each voxel block of the plurality of voxel blocks; comparing each of the respective 3D representation values with a corresponding respective previous 3D representation value to estimate a distance difference for each voxel block of the plurality of voxel blocks; identifying one or more voxel blocks of the plurality of voxel blocks having a distance difference greater than a distance threshold; generating a 3D mesh based on the identified one or more voxel blocks; and generating a simplified 3D mesh based on the generated 3D mesh.

In some aspects, non-transitory computer-readable medium having stored thereon instructions that, when executed by at least one processor, cause the at least one processor to: select a plurality of voxel blocks for the scene based on depth data and pose data indicative of a perspective of the depth data; generate, based on at least one of the depth data or the pose data, a respective 3D representation value for each voxel block of the plurality of voxel blocks; compare each of the respective 3D representation values with a corresponding respective previous 3D representation value to estimate a distance difference for each voxel block of the plurality of voxel blocks; identify one or more voxel blocks of the plurality of voxel blocks having a distance difference greater than a distance threshold; generate a 3D mesh based on the identified one or more voxel blocks; and generate a simplified 3D mesh based on the generated 3D mesh.

In some aspects, an apparatus for 3D reconstruction of a scene is provided. The apparatus includes: means for selecting a plurality of voxel blocks for the scene based on depth data and pose data indicative of a perspective of the depth data; means for generating, based on at least one of the depth data or the pose data, a respective 3D representation value for each voxel block of the plurality of voxel blocks; means for comparing each of the respective 3D representation values with a corresponding respective previous 3D representation value to estimate a distance difference for each voxel block of the plurality of voxel blocks; means for identifying one or more voxel blocks of the plurality of voxel blocks having a distance difference greater than a distance threshold; means for generating a 3D mesh based on the identified one or more voxel blocks; and means for generating a simplified 3D mesh based on the generated 3D mesh.

In some aspects, an apparatus for 3D reconstruction of a scene is provided. The apparatus at least one memory and at least one processor coupled to the at least one memory and configured to: select a plurality of voxel blocks for the scene based on depth data and pose data indicative of a perspective of the depth data; generate, based on the plurality of voxel blocks, a 3D mesh including a plurality of vertices; compare each vertex of the plurality of vertices of the generated 3D mesh with a corresponding respective previous vertex to estimate a distance difference for each vertex of the plurality of vertices of the 3D mesh; identify one or more portions of the generated 3D mesh corresponding to vertices of the plurality of vertices having a distance difference greater than a distance threshold; and generate a simplified 3D mesh based on the one or more portions of the generated 3D mesh.

In some aspects, a method for 3D reconstruction of a scene is provided. The method includes: selecting a plurality of voxel blocks for the scene based on depth data and pose data indicative of a perspective of the depth data; generating, based on the plurality of voxel blocks, a 3D mesh comprising a plurality of vertices; comparing each vertex of the plurality of vertices of the generated 3D mesh with a corresponding respective previous vertex to estimate a distance difference for each vertex of the plurality of vertices of the 3D mesh; identifying one or more portions of the generated 3D mesh corresponding to vertices of the plurality of vertices having a distance difference greater than a distance threshold; and generating a simplified 3D mesh based on the one or more portions of the generated 3D mesh.

In some aspects, non-transitory computer-readable medium having stored thereon instructions that, when executed by at least one processor, cause the at least one processor to: select a plurality of voxel blocks for the scene based on depth data and pose data indicative of a perspective of the depth data; generate, based on the plurality of voxel blocks, a 3D mesh including a plurality of vertices; compare each vertex of the plurality of vertices of the generated 3D mesh with a corresponding respective previous vertex to estimate a distance difference for each vertex of the plurality of vertices of the 3D mesh; identify one or more portions of the generated 3D mesh corresponding to vertices of the plurality of vertices having a distance difference greater than a distance threshold; and generate a simplified 3D mesh based on the one or more portions of the generated 3D mesh.

In some aspects, an apparatus for 3D reconstruction of a scene is provided. The apparatus includes: means for selecting a plurality of voxel blocks for the scene based on depth data and pose data indicative of a perspective of the depth data; means for generating, based on the plurality of voxel blocks, a 3D mesh comprising a plurality of vertices; means for comparing each vertex of the plurality of vertices of the generated 3D mesh with a corresponding respective previous vertex to estimate a distance difference for each vertex of the plurality of vertices of the 3D mesh; means for identifying one or more portions of the generated 3D mesh corresponding to vertices of the plurality of vertices having a distance difference greater than a distance threshold; and means for generating a simplified 3D mesh based on the one or more portions of the generated 3D mesh.

In some aspects, an apparatus for 3D reconstruction of a scene is provided. The apparatus includes at least one memory and at least one processor coupled to the at least one memory and configured to: select a plurality of voxel blocks for the scene based on depth data and pose data indicative of a perspective of the depth data; generate, based on the plurality of voxel blocks, a 3D mesh; generate, based on the generated 3D mesh, a simplified 3D mesh including a plurality of vertices; compare each vertex of the plurality of vertices of the simplified 3D mesh with a corresponding respective previous vertex to estimate a distance difference for each vertex of the plurality of vertices of the simplified 3D mesh; identify one or more portions of the simplified 3D mesh corresponding to vertices of the plurality of vertices having a distance difference greater than a distance threshold; and generate a final 3D mesh based on the one or more portions of the simplified 3D mesh.

In some aspects, a method for 3D reconstruction of a scene is provided. The method includes: selecting a plurality of voxel blocks for the scene based on depth data and pose data indicative of a perspective of the depth data; generating, based on the plurality of voxel blocks, a 3D mesh; generating, based on the generated 3D mesh, a simplified 3D mesh comprising a plurality of vertices; comparing each vertex of the plurality of vertices of the simplified 3D mesh with a corresponding respective previous vertex to estimate a distance difference for each vertex of the plurality of vertices of the simplified 3D mesh; identifying one or more portions of the simplified 3D mesh corresponding to vertices of the plurality of vertices having a distance difference greater than a distance threshold; and generating a final 3D mesh based on the one or more portions of the simplified 3D mesh.

In some aspects, non-transitory computer-readable medium having stored thereon instructions that, when executed by at least one processor, cause the at least one processor to: select a plurality of voxel blocks for the scene based on depth data and pose data indicative of a perspective of the depth data; generate, based on the plurality of voxel blocks, a 3D mesh; generate, based on the generated 3D mesh, a simplified 3D mesh including a plurality of vertices; compare each vertex of the plurality of vertices of the simplified 3D mesh with a corresponding respective previous vertex to estimate a distance difference for each vertex of the plurality of vertices of the simplified 3D mesh; identify one or more portions of the simplified 3D mesh corresponding to vertices of the plurality of vertices having a distance difference greater than a distance threshold; and generate a final 3D mesh based on the one or more portions of the simplified 3D mesh.

In some aspects, an apparatus for 3D reconstruction of a scene is provided. The apparatus includes: means for selecting a plurality of voxel blocks for the scene based on depth data and pose data indicative of a perspective of the depth data; generating, based on the plurality of voxel blocks, a 3D mesh; means for generating, based on the generated 3D mesh, a simplified 3D mesh comprising a plurality of vertices; means for comparing each vertex of the plurality of vertices of the simplified 3D mesh with a corresponding respective previous vertex to estimate a distance difference for each vertex of the plurality of vertices of the simplified 3D mesh; means for identifying one or more portions of the simplified 3D mesh corresponding to vertices of the plurality of vertices having a distance difference greater than a distance threshold; and means for generating a final 3D mesh based on the one or more portions of the simplified 3D mesh.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an example architecture of an image capture and processing system, in accordance with some aspects of the disclosure.

FIG. 2 is a block diagram illustrating an example of interactions between components of an image capture and processing system, in accordance with some aspects of the disclosure.

FIG. 3 is a block diagram illustrating an example device that may employ a color metadata buffer for 3D reconstruction, in accordance with some aspects of the disclosure.

FIG. 4 is a diagram illustrating an example of a 3D surface reconstruction of a scene modeled as a volume grid, in accordance with some aspects of the disclosure.

FIG. 5 is a diagram illustrating an example of a hash mapping function for indexing blocks (e.g., voxel blocks) in a volume grid, in accordance with some aspects of the disclosure.

FIG. 6 is a diagram illustrating an example of a block (e.g., a voxel block), in accordance with some aspects of the disclosure.

FIG. 7 is a diagram illustrating an example of a truncated signed distance function (TSDF) volume reconstruction, in accordance with some aspects of the disclosure.

FIG. 8 is a graph illustrating examples of ratios of blocks passed to mesh extraction, where the ratios are determined based on mesh hysteresis, in accordance with some aspects of the disclosure.

FIG. 9 is a diagram illustrating an example of a 3D mesh, generated for a 3D structure, being simplified based on mesh simplification, in accordance with some aspects of the disclosure.

FIG. 10 is a diagram illustrating an example of a configuration of a process of mesh hysteresis and mesh simplification for efficient block-based 3DR, where the mesh hysteresis is performed at the beginning of efficient 3D mesh extraction, in accordance with some aspects of the disclosure.

FIG. 11 is a diagram illustrating an example of a process for mesh hysteresis performed by the mesh hysteresis engine of FIG. 10, in accordance with some aspects of the disclosure.

FIG. 12 is a conceptual diagram illustrating representations of representations of surface extraction and mesh generation at a voxel level, in accordance with some aspects of the disclosure.

FIG. 13 is a diagram illustrating an example of a configuration of a process 1300 for mesh hysteresis and mesh simplification for efficient block-based 3DR, where the mesh hysteresis is performed on an unsimplified 3D mesh, in accordance with some aspects of the disclosure.

FIG. 14 is a diagram illustrating an example of a process for mesh hysteresis performed by the mesh hysteresis engine of FIG. 13, in accordance with some aspects of the disclosure.

FIG. 15 is a diagram illustrating an example of a configuration of a process for mesh hysteresis and mesh simplification for efficient block-based 3DR, where the mesh hysteresis is performed on a simplified 3D mesh, in accordance with some aspects of the disclosure.

FIG. 16 is a diagram illustrating an example of a configuration of a process for 3D representation simplification, in accordance with some aspects of the disclosure.

FIG. 17 is a diagram illustrating an example of a configuration of a process employing mesh simplification using adaptive block fusion, in accordance with some aspects of the disclosure.

FIG. 18 is a diagram illustrating an example of a process for hierarchical mesh simplification using adaptive block fusion, in accordance with some aspects of the disclosure.

FIG. 19 is a diagram illustrating examples of block meshes that may be generated during hierarchical mesh simplification using adaptive block fusion, in accordance with some aspects of the disclosure.

FIG. 20 is a flow diagram illustrating an example of a process for image processing, in accordance with some aspects of the disclosure.

FIG. 21 is a flow diagram illustrating another example of a process for image processing, in accordance with some aspects of the disclosure.

FIG. 22 is a flow diagram illustrating yet another example of a process for image processing, in accordance with some aspects of the disclosure.

FIG. 23 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

A camera is a device that receives light and captures image frames, such as still images or video frames, using an image sensor. The terms “image,” “image frame,” and “frame” are used interchangeably herein. Cameras may include processors, such as image signal processors (ISPs), that can receive one or more image frames and process the one or more image frames. For example, a raw image frame captured by a camera sensor can be processed by an ISP to generate a final image. Processing by the ISP can be performed by a plurality of filters or processing blocks being applied to the captured image frame, such as denoising or noise filtering, edge enhancement, color balancing, contrast, intensity adjustment (such as darkening or lightening), tone adjustment, among others. Image processing blocks or modules may include lens/sensor noise correction, Bayer filters, de-mosaicing, color conversion, correction or enhancement/suppression of image attributes, denoising filters, sharpening filters, among others.

Cameras can be configured with a variety of image capture and image processing operations and settings. The different settings result in images with different appearances. Some camera operations are determined and applied before or during capture of the image, such as automatic exposure control (AEC) and automatic white balance (AWB) processing. Additional camera operations applied before, during, or after capture of an image include operations involving zoom (e.g., zooming in or out), ISO, aperture size, f/stop, shutter speed, and gain. Other camera operations can configure post-processing of an image, such as alterations to contrast, brightness, saturation, sharpness, levels, curves, or colors.

As previously mentioned, in recent decades, there has been a demand for three-dimensional (3D) content for computer graphics, virtual reality, and communications, triggering a change in emphasis for the requirements. Many existing systems for constructing 3D models are built around specialized hardware resulting in a high cost, and often cannot satisfy the requirements of these new applications. The requirements have stimulated the use of digital imaging (e.g., using images from cameras) for 3D reconstruction.

In some cases, volume blocks (e.g., voxel blocks) can be utilized to reconstruct a 3D scene from two-dimensional (2D) images, such as stereo images obtained from a stereo camera. A voxel block represents a value on a regular grid in 3D space. As with pixels in a 2D bitmap, voxel blocks do not have their position (e.g., coordinates) explicitly encoded within their values. Instead, rendering systems infer the position of a voxel block based upon its position relative to other voxel blocks (e.g., its position in the data structure that makes up a single volumetric image).

In some examples, a system can perform 3D reconstruction (3DR) using depth frames and an associated live camera pose estimate for 3D scene reconstruction. In some cases, when performing 3D surface reconstruction, the system can model the scene as a 3D sparse volumetric representation (e.g., referred to as a volume grid). The volume grid can contain a set of voxel blocks, which are each indexed by their position in space with a sparse data representation (e.g., only storing blocks that surround an object and/or obstacle). In some cases, the scene can be divided into a dense volumetric representation (as opposed to a sparse volumetric representation).

In one illustrative example, a system can perform 3DR to reconstruct a 3D scene from 2D depth frames and color frames. The system can divide the scene into 3D blocks (e.g., voxel blocks or volume blocks, as noted previously). For example, the system may project each voxel block onto a 2D depth frame and a 2D image to determine the depth and/or color of the voxel block. Once all of the voxel blocks that refer to (e.g., are associated with) this depth frame and color frame are updated accordingly, the process can repeat for a new depth frame and color frame pair or set. In some cases, color integration may not be needed. For instance, some 3DR systems may operate on depth and not color. The systems and techniques described herein can apply to depth only 3DR systems and to 3DR systems that operate on depth and color.

As previously mentioned, in 3DR, 3D scenes are represented using a 3D volume of points called voxel blocks, where each voxel block typically carries implicit surface information, such as in the form of a truncated Signed Distance Function (TSDF) value and a weight for depth integration. The TSDF value is a measure of distance of the voxel block from a surface, and the weight is a measure of the reliability of the TSDF value. A TSDF weight can be estimated using various approaches, such as a simple counter (e.g., a binary weight of 1 or 0), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to 1.

A 3DR system may use a sequence of depth maps of a scene with their corresponding six (6) degrees of freedom (DoF) poses as an input. The depth maps can be generated using deep learning (DL) algorithms, non-DL algorithms, and/or other depth estimation methods. A 3D space of the scene can be uniformly sampled along the X, Y, and Z directions. The 3D space can be divided into fixed size volumes (e.g., block volumes with a fixed number of samples).

A 3DR system may include three stages, including block selection, depth integration, and surface extraction. During block selection, blocks that have surfaces or are located close to a surface can be selected. These blocks can then be allocated into memory. In depth integration (also referred to as block integration), all voxel blocks within a block volume can be iterated over and an updated TSDF value weight can be calculated. In surface extraction, marching cubes can be used to determine triangular surfaces in the blocks.

3D surface reconstruction (3DR) is a fundamental task to understand the geometry of a 3D scene, which enables the development of many interesting use cases, including plane detection, obstacle avoidance, occlusion rendering, etc. However, as this task deals with the processing of the 3D space, the compute requirements can grow rapidly due to significant amounts of data to be processed as compared to 2D applications. Due to these large compute requirements, commercial solutions are mainly based on traditional computer vision to compute truncated signed distance functions (TSDFs) as 3D representations from 2D depth images. By breaking down the 3D space into smaller entities known as blocks, TSDF computation can be substantially accelerated on hardware platforms. However, to retrieve the geometry needed by down-stream applications, a triangular mesh needs to be extracted from the TSDF representation using a marching cubes algorithm. This extraction is an expensive operation in terms of compute, bandwidth, and memory, which can result in a mesh with a considerable number of vertices and edges to describe surfaces in the 3D scene. Therefore, end-to-end 3D reconstruction is a resource intensive task, and any optimization done within the pipeline is critical to manage the huge power demands of 3DR, especially for edge devices (e.g., mobile devices).

As such, improved systems and techniques for 3D reconstruction that conserves compute and power resources can be beneficial.

In some aspects of the present disclosure, systems, apparatuses, methods (also referred to as processes), and computer-readable media (collectively referred to herein as “systems and techniques”) are described herein for efficient block-based 3D reconstruction system with mesh hysteresis and simplification.

Various aspects relate generally to image processing. Some aspects more specifically relate to systems and techniques that provide solutions for a framework level optimization for 3DR. This efficient 3DR framework benefits from employing two engines, namely mesh hysteresis (e.g., a mesh hysteresis engine) and mesh simplification (e.g., a mesh simplification engine). Mesh hysteresis ensures that whenever and wherever there is no significant change in the 3D scene, compute and power are not expended for the extraction and management of a new mesh. On the other hand, mesh simplification ensures that whenever and wherever a new mesh is extracted, the new mesh is extracted with the minimum number of vertices and edges to avoid redundancies. Subsequently, by employing these two engines (e.g., mesh hysteresis engine and mesh simplification engine) in tandem, the computational and power demands of 3DR can be substantially reduced.

Particular aspects of the subject matter described in this disclosure can be implemented to realize one or more of the following potential advantages. In one or more examples, the systems and techniques have the benefit of providing an efficient framework for 3D surface reconstruction (e.g., which is a fundamental task for VR/MR/AR) with a reduction in needed compute and bandwidth resources, which has a direct impact on power conservation.

In one or more examples, during operation of the systems and techniques for three-dimensional (3D) reconstruction of a scene, one or more processors (e.g., of a voxel block selection engine) can select a plurality of voxel blocks for the scene based on depth data and pose data indicative of a perspective of the depth data. One or more processors (e.g., of a depth fusion and TSDF integration engine) can generate, based on at least one of the depth data or the pose data, a respective 3D representation value for each voxel block of the plurality of voxel blocks. One or more processors (e.g., of a mesh hysteresis engine) can compare each of the respective 3D representation values with a corresponding respective previous 3D representation value to estimate a distance difference for each voxel block of the plurality of voxel blocks. The one or more processors (e.g., of the mesh hysteresis engine) can determine, based on the distance difference being greater than a distance threshold, one or more voxel blocks of the plurality of voxel blocks. One or more processors (e.g., of a surface extraction engine) can generate a 3D mesh (e.g., an unsimplified 3D mesh) based on the one or more voxel blocks of the plurality of voxel blocks. One or more processors (e.g., of a mesh simplification engine) can generate a simplified 3D mesh based on the 3D mesh (e.g., the unsimplified 3D mesh).

In one or more examples, the respective 3D representation values can be truncated signed distance function (TSDF) values or point cloud values. In some examples, the TSDF values can be generated based on deep-learning that operates on one or more red, green, blue (RGB) images of the scene and the pose data. In one or more examples, the 3D mesh (e.g., the unsimplified 3D mesh) can be generated based on a marching cube algorithm. In some examples, the simplified 3D mesh can be generated based on fusing one or more triangles together within the 3D mesh.

In some examples, during operation of the systems and techniques for 3D reconstruction of a scene, one or more processors (e.g., of a voxel block selection engine) can select a plurality of voxel blocks for the scene based on depth data and pose data indicative of a perspective of the depth data. One or more processors (e.g., of a surface extraction engine) can generate, based on the plurality of voxel blocks, a 3D mesh (e.g., an unsimplified 3D mesh) comprising a plurality of vertices. One or more processors (e.g., of a mesh hysteresis engine) can compare each vertex of the plurality of vertices of the 3D mesh (e.g., the unsimplified 3D mesh) with a corresponding respective previous vertex to estimate a distance difference for each vertex of the plurality of vertices of the 3D mesh. The one or more processors (e.g., of the mesh hysteresis engine) can determine, based on the distance difference being greater than a distance threshold, one or more portions of the 3D mesh. One or more processors (e.g., of a mesh simplification engine) can generate a simplified 3D mesh based on the one or more portions of the 3D mesh.

In one or more examples, during operation of the systems and techniques for 3D reconstruction of a scene, one or more processors (e.g., of a voxel block selection engine) can select a plurality of voxel blocks for the scene based on depth data and pose data indicative of a perspective of the depth data. One or more processors (e.g., of a surface extraction engine) can generate, based on the plurality of voxel blocks, a 3D mesh (e.g., an unsimplified 3D mesh). One or more processors (e.g., of a mesh simplification engine) can generate, based on the 3D mesh, a simplified 3D mesh comprising a plurality of vertices. One or more processors (e.g., of a mesh hysteresis engine) can compare each vertex of the plurality of vertices of the simplified 3D mesh with a corresponding respective previous vertex to estimate a distance difference for each vertex of the plurality of vertices of the simplified 3D mesh. The one or more processors (e.g., of the mesh hysteresis engine) can determine, based on the distance difference being greater than a distance threshold, one or more portions of the simplified 3D mesh. One or more processors can generate a final 3D mesh based on the one or more portions of the simplified 3D mesh.

Additional aspects of the present disclosure are described in more detail below. Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

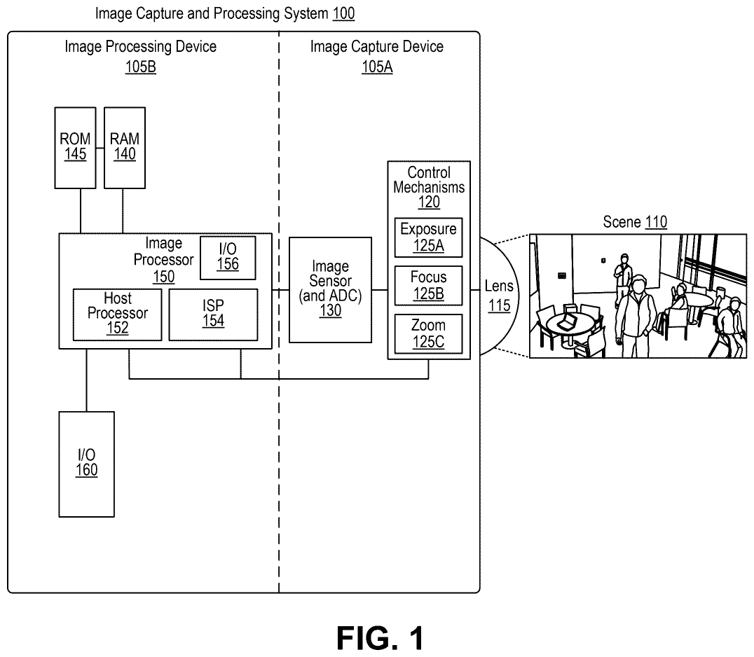

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. A lens 115 of the system 100 faces a scene 110 and receives light from the scene 110. The lens 115 bends the light toward the image sensor 130. The light received by the lens 115 passes through an aperture controlled by one or more control mechanisms 120 and is received by an image sensor 130.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo, thereby adjusting focus. In some cases, additional lenses may be included in the device 105A, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), or some combination thereof. The focus setting may be determined using the control mechanism 120, the image sensor 130, and/or the image processor 150. The focus setting may be referred to as an image capture setting and/or an image processing setting.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference) with a negative (e.g., diverging, concave) lens between them. In some cases, the zoom control mechanism 125C moves one or more of the lenses in the afocal zoom system, such as the negative lens and one or both of the positive lenses.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different color filters, and may thus measure light matching the color of the filter covering the photodiode. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter. Other types of color filters may use yellow, magenta, and/or cyan (also referred to as “emerald”) color filters instead of or in addition to red, blue, and/or green color filters. Some image sensors may lack color filters altogether, and may instead use different photodiodes throughout the pixel array (in some cases vertically stacked). The different photodiodes throughout the pixel array can have different spectral sensitivity curves, therefore responding to different wavelengths of light. Monochrome image sensors may also lack color filters and therefore lack color depth.

In some cases, the image sensor 130 may alternately or additionally include opaque and/or reflective masks that block light from reaching certain photodiodes, or portions of certain photodiodes, at certain times and/or from certain angles, which may be used for phase detection autofocus (PDAF). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

The image processor 150 may include one or more processors, such as one or more image signal processors (ISPs) (including ISP 154), one or more host processors (including host processor 152), and/or one or more of any other type of processor 2510 discussed with respect to the computing system 2500. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/2520, read-only memory (ROM) 145/2525, a cache 2512, a memory unit 2515, another storage device 2530, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices 2535, any other input devices 2545, or some combination thereof. In some cases, a caption may be input into the image processing device 105B through a physical keyboard or keypad of the I/O devices 160, or through a virtual keyboard or keypad of a touchscreen of the I/O devices 160. The I/O 160 may include one or more ports, jacks, or other connectors that enable a wired connection between the device 105B and one or more peripheral devices, over which the device 105B may receive data from the one or more peripheral device and/or transmit data to the one or more peripheral devices. The I/O 160 may include one or more wireless transceivers that enable a wireless connection between the device 105B and one or more peripheral devices, over which the device 105B may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

The host processor 152 can configure the image sensor 130 with new parameter settings (e.g., via an external control interface such as I2C, I3C, SPI, GPIO, and/or other interface). In one illustrative example, the host processor 152 can update exposure settings used by the image sensor 130 based on internal processing results of an exposure control algorithm from past image frames.

In some examples, the host processor 152 can perform electronic image stabilization (EIS). For instance, the host processor 152 can determine a motion vector corresponding to motion compensation for one or more image frames. In some aspects, host processor 152 can position a cropped pixel array (“the image window”) within the total array of pixels. The image window can include the pixels that are used to capture images. In some examples, the image window can include all of the pixels in the sensor, except for a portion of the rows and columns at the periphery of the sensor. In some cases, the image window can be in the center of the sensor while the image capture device 105A is stationary. In some aspects, the peripheral pixels can surround the pixels of the image window and form a set of buffer pixel rows and buffer pixel columns around the image window. Host processor 152 can implement EIS and shift the image window from frame to frame of video, so that the image window tracks the same scene over successive frames (e.g., assuming that the subject does not move). In some examples in which the subject moves, host processor 152 can determine that the scene has changed.

In some examples, the image window can include at least 95% (e.g., 95% to 99%) of the pixels on the sensor. The first region of interest (ROI) (e.g., used for AE and/or AWB) may include the image data within the field of view of at least 95% (e.g., 95% to 99%) of the plurality of imaging pixels in the image sensor 130 of the image capture device 105A. In some aspects, a number of buffer pixels at the periphery of the sensor (outside of the image window) can be reserved as a buffer to allow the image window to shift to compensate for jitter. In some cases, the image window can be moved so that the subject remains at the same location within the adjusted image window, even though light from the subject may impinge on a different region of the sensor. In another example, the buffer pixels can include the ten topmost rows, ten bottommost rows, ten leftmost columns and ten rightmost columns of pixels on the sensor. In some configurations, the buffer pixels are not used for AF, AE or AWB when the image capture device 105A is stationary and the buffer pixels not included in the image output. If jitter moves the sensor to the left by twice the width of a column of pixels between frames, the EIS algorithm can be used to shift the image window to the right by two columns of pixels, so the captured image shows the same scene in the next frame as in the current frame. Host processor 152 can use EIS to smoothen the transition from one frame to the next.

In some aspects, the host processor 152 can also dynamically configure the parameter settings of the internal pipelines or modules of the ISP 154 to match the settings of one or more input image frames from the image sensor 130 so that the image data is correctly processed by the ISP 154. Processing (or pipeline) blocks or modules of the ISP 154 can include modules for lens/sensor noise correction, de-mosaicing, color conversion, correction or enhancement/suppression of image attributes, denoising filters, sharpening filters, among others. The settings of different modules of the ISP 154 can be configured by the host processor 152. Each module may include a large number of tunable parameter settings. Additionally, modules may be co-dependent as different modules may affect similar aspects of an image. For example, denoising and texture correction or enhancement may both affect high frequency aspects of an image. As a result, a large number of parameters are used by an ISP to generate a final image from a captured raw image.

In some cases, the image capture and processing system 100 may perform one or more of the image processing functionalities described above automatically. For instance, one or more of the control mechanisms 120 may be configured to perform auto-focus operations, auto-exposure operations, and/or auto-white-balance operations. In some embodiments, an auto-focus functionality allows the image capture device 105A to focus automatically prior to capturing the desired image. Various auto-focus technologies exist. For instance, active autofocus technologies determine a range between a camera and a subject of the image via a range sensor of the camera, typically by emitting infrared lasers or ultrasound signals and receiving reflections of those signals. In addition, passive auto-focus technologies use a camera's own image sensor to focus the camera, and thus do not require additional sensors to be integrated into the camera. Passive AF techniques include Contrast Detection Auto Focus (CDAF), Phase Detection Auto Focus (PDAF), and in some cases hybrid systems that use both. The image capture and processing system 100 may be equipped with these or any additional type of auto-focus technology.

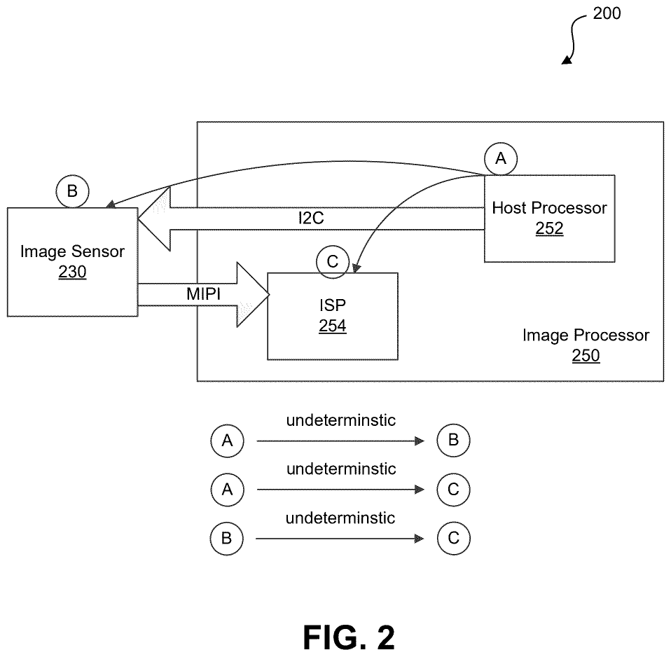

Synchronization between the image sensor 130 and the ISP 154 is important in order to provide an operational image capture system that generates high quality images without interruption and/or failure. FIG. 2 is a block diagram illustrating an example of an image capture and processing system 200 including an image processor 250 (including host processor 252 and ISP 254) in communication with an image sensor 230. The configuration shown in FIG. 2 is illustrative of traditional synchronization techniques used in camera systems. In general, the host processor 252 attempts to provide synchronization between the image sensor 230 and the ISP 254 using fixed periods of time by separately communicating with the image sensor 230 and the ISP 254. For example, in traditional camera systems, the host processor 252 communicates with the image sensor 230 (e.g., over an I2C port) and programs the image sensor 230 parameters with a first fixed period of time, such as 2-frame periods ahead of when that image frame will be processed by the ISP 254. The host processor 252 communicates with the ISP 254 (e.g., over an internal AHB bus or other interface) and programs the ISP 254 parameter settings with a second fixed period of time, such as 1-frame period ahead of when that image frame will be processed by the ISP 254.

The image sensor 230 can send image frames to the ISP 254 (B-to-C in FIG. 2), such as over an MIPI CSI-2 PHY port or interface, or other suitable interface. However, the communication between the host processor 252 and the image sensor 230 (shown as from A to B) is undeterministic. Similarly, the communication between the image sensor 230 and the ISP 254 (shown as from B to C) and the communication the host processor 252 and the ISP 254 (shown as from A to C) are also undeterministic. For example, there can be varying latencies in programming of the image sensor 230 and the ISP 254 by the host processor 252, which can result in a parameter settings mismatch between the sensor and the ISP. The latencies can be due to high CPU usage, congestion in one or more I/O ports, and/or due to other factors.

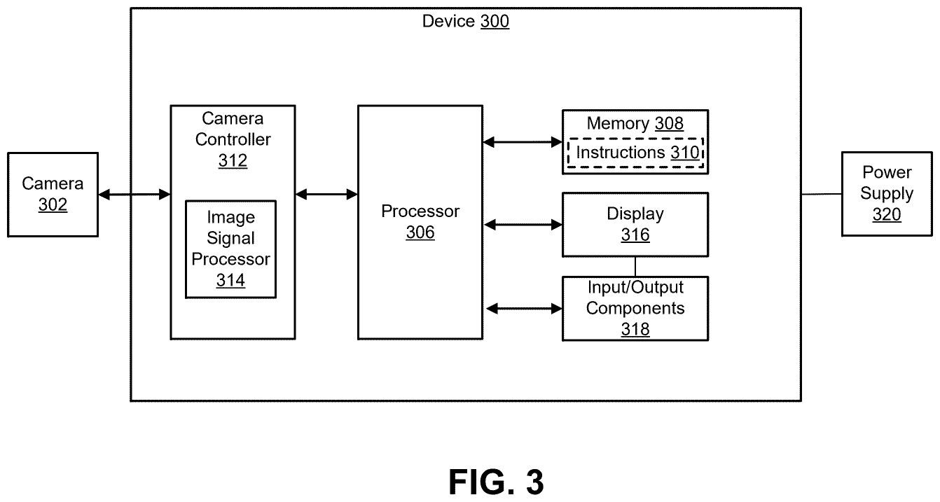

FIG. 3 is a block diagram of an example device 300 that may employ a color metadata buffer for 3D reconstruction. Device 300 may include or may be coupled to a camera 302, and may further include a processor 306, a memory 308 storing instructions 310, a camera controller 312, a display 316, and a number of input/output (I/O) components 318 including one or more microphones (not shown). The example device 300 may be any suitable device capable of capturing and/or storing images or video including, for example, wired and wireless communication devices (such as camera phones, smartphones, tablets, security systems, smart home devices, connected home devices, surveillance devices, internet protocol (IP) devices, dash cameras, laptop computers, desktop computers, automobiles, drones, aircraft, and so on), digital cameras (including still cameras, video cameras, and so on), or any other suitable device. The device 300 may include additional features or components not shown. For example, a wireless interface, which may include a number of transceivers and a baseband processor, may be included for a wireless communication device. Device 300 may include or may be coupled to additional cameras other than the camera 302. The disclosure should not be limited to any specific examples or illustrations, including the example device 300.

Camera 302 may be capable of capturing individual image frames (such as still images) and/or capturing video (such as a succession of captured image frames). Camera 302 may include one or more image sensors (not shown for simplicity) and shutters for capturing an image frame and providing the captured image frame to camera controller 312. Although a single camera 302 is shown, any number of cameras or camera components may be included and/or coupled to device 300. For example, the number of cameras may be increased to achieve greater depth determining capabilities or better resolution for a given FOV.

Memory 308 may be a non-transient or non-transitory computer readable medium storing computer-executable instructions 310 to perform all or a portion of one or more operations described in this disclosure. Device 300 may also include a power supply 320, which may be coupled to or integrated into the device 300.

Processor 306 may be one or more suitable processors capable of executing scripts or instructions of one or more software programs (such as the instructions 310) stored within memory 308. In some aspects, processor 306 may be one or more general purpose processors that execute instructions 310 to cause device 300 to perform any number of functions or operations. In additional or alternative aspects, processor 306 may include integrated circuits or other hardware to perform functions or operations without the use of software. While shown to be coupled to each other via processor 306 in the example of FIG. 3, processor 306, memory 308, camera controller 312, display 316, and I/O components 318 may be coupled to one another in various arrangements. For example, processor 306, memory 308, camera controller 312, display 316, and/or I/O components 318 may be coupled to each other via one or more local buses (not shown for simplicity).

Display 316 may be any suitable display or screen allowing for user interaction and/or to present items (such as captured images and/or videos) for viewing by the user. In some aspects, display 316 may be a touch-sensitive display. Display 316 may be part of or external to device 300. Display 316 may comprise an LCD, LED, OLED, or similar display. I/O components 318 may be or may include any suitable mechanism or interface to receive input (such as commands) from the user and/or to provide output to the user. For example, I/O components 318 may include (but are not limited to) a graphical user interface, keyboard, mouse, microphone and speakers, and so on.

Camera controller 312 may include an image signal processor (ISP) 314, which may be (or may include) one or more image signal processors to process captured image frames or videos provided by camera 302. For example, ISP 314 may be configured to perform various processing operations for automatic focus (AF), automatic white balance (AWB), and/or automatic exposure (AE), which may also be referred to as automatic exposure control (AEC). Examples of image processing operations include, but are not limited to, cropping, scaling (e.g., to a different resolution), image stitching, image format conversion, color interpolation, image interpolation, color processing, image filtering (e.g., spatial image filtering), and/or the like.

In some example implementations, camera controller 312 (such as the ISP 314) may implement various functionality, including imaging processing and/or control operation of camera 302. In some aspects, ISP 314 may execute instructions from a memory (such as instructions 310 stored in memory 308 or instructions stored in a separate memory coupled to ISP 314) to control image processing and/or operation of camera 302. In other aspects, ISP 314 may include specific hardware to control image processing and/or operation of camera 302. ISP 314 may alternatively or additionally include a combination of specific hardware and the ability to execute software instructions.

While not shown in FIG. 3, in some implementations, ISP 314 and/or camera controller 312 may include an AF module, an AWB module, and/or an AE module. ISP 314 and/or camera controller 312 may be configured to execute an AF process, an AWB process, and/or an AE process. In some examples, ISP 314 and/or camera controller 312 may include hardware-specific circuits (e.g., an application-specific integrated circuit (ASIC)) configured to perform the AF, AWB, and/or AE processes. In other examples, ISP 314 and/or camera controller 312 may be configured to execute software and/or firmware to perform the AF, AWB, and/or AE processes. When configured in software, code for the AF, AWB, and/or AE processes may be stored in memory (such as instructions 310 stored in memory 308 or instructions stored in a separate memory coupled to ISP 314 and/or camera controller 312). In other examples, ISP 314 and/or camera controller 312 may perform the AF, AWB, and/or AE processes using a combination of hardware, firmware, and/or software. When configured as software, AF, AWB, and/or AE processes may include instructions that configure ISP 314 and/or camera controller 312 to perform various image processing and device managements tasks, including the techniques of this disclosure.

As previously mentioned, recently, there has been a demand for 3D content for computer graphics, virtual reality, and communications, that has triggered a change in emphasis for the requirements. Many existing systems for constructing 3D models are built around specialized hardware that results in a high cost, which often cannot satisfy the requirements of these new applications. This need has stimulated the use of digital imaging facilities (e.g., cameras) for 3D reconstruction.

Currently, volume blocks (e.g., voxel blocks) are often used to reconstruct a 3D scene from 2D images (e.g., stereo images obtained from a stereo camera). A voxel block will be used herein as an example of blocks (e.g., 3D blocks or volume blocks). A voxel block can represent a value on a regular grid in 3D space. As with pixels in a 2D bitmap, voxel blocks themselves do not have their position (e.g., coordinates) explicitly encoded within their values. Instead, rendering systems infer the position of a voxel block based upon its position relative to other voxel blocks (e.g., its position in the data structure that makes up a single volumetric image).

3DR utilizes depth frames with an associated live camera pose estimate for scene reconstruction. In 3D surface reconstruction, the scene can be modeled as a 3D sparse volumetric representation (e.g., that can be referred to as a volume grid). The volume grid contains a set of voxel blocks that are indexed by their position in space with a sparse data representation (e.g., only storing blocks that surround an object and/or obstacle). For example, a room with a size of four meters (m) by four m by five m may be modeled with a volume grid having a total of 1.25 million (M) voxel blocks, where each voxel block has a four centimeter block dimension. In some examples, for this room, the occupied voxel blocks may only be about ten to fifteen percent.

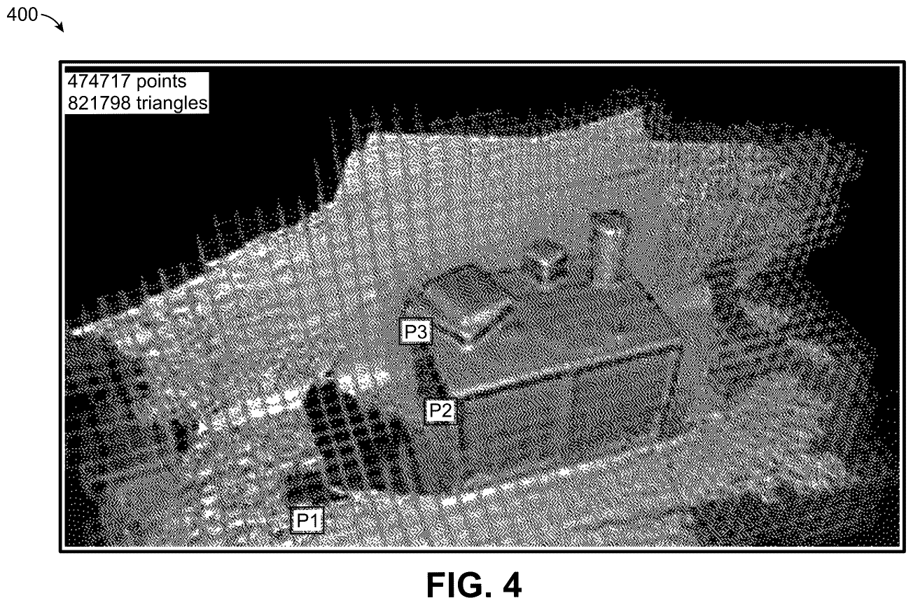

FIG. 4 shows an example of a scene that has been modeled as a 3D sparse volumetric representation for 3DR. In particular, FIG. 4 is a diagram illustrating an example of a 3D surface reconstruction 400 of a scene modeled with an overlay of a volume grid containing voxel blocks. For 3DR, a camera (e.g., a stereo camera) may take photos of the scene from various different view points and angles. For example, a camera may take a photo of the scene when the camera is located at position P1. Once multiple photos have been taken of the scene, a 3D representation of the scene can be constructed by modeling the scene as a volume grid with 3D blocks (e.g., voxel blocks).

In one or more examples, an image (e.g., a photo) of a 3D block (e.g., voxel block) located at point P2 within the scene may be taken by a camera (e.g., a stereo camera) located at point P1 with a certain camera pose (e.g., at a certain angle). The camera can capture depth and in some cases can also capture color. From this image, it can be determined that there is an object located at point P2 with a certain depth and, as such, there is a surface. As such, it can be determined that there is an object that maps to this particular 3D block. An image of a 3D block located at point P3 within the scene may be taken by the same camera located at the point P1 with a different camera pose (e.g., with a different angle). From this image, it can be determined that there is an object located at point P3 with a certain depth and having a surface. As such, it can be determined that there is an object that maps to this particular 3D block (e.g., voxel block). An integrate process can occur where all of the blocks within the scene are passed through an integrate function. The integrate function can determine depth information for each of the blocks from the depth frame and can update each block to indicate whether the block has a surface or not. In cases where the 3DR algorithm or system integrates color, the blocks that are determined to have a surface can then be updated with a color. In other cases, for 3DR systems that operate on depth (without color), color may not be added to or integrated with the blocks.

In one or more examples, the pose of the camera can indicate the location of the camera (e.g., which may be indicated by location coordinates X, Y) and the angle that the camera (e.g., which is the angle that the camera is positioned in for capturing the image). Each block (e.g., the block located at point P2) has a location (e.g., which may be indicated by location coordinates X, Y, Z). The pose of the camera and the location of each block can be used to map each block to world coordinates for the whole scene.

In one or more examples, to achieve fast multiple access to 3D blocks (e.g., voxel blocks), instead of using a large memory lookup table, various different volume block representations may be used to index the blocks in the 3D scene to store data where the measurements are observed. Volume block representations that may be employed can include, but are not limited to, a hash map lookup, an octree, and a large blocks implementation.

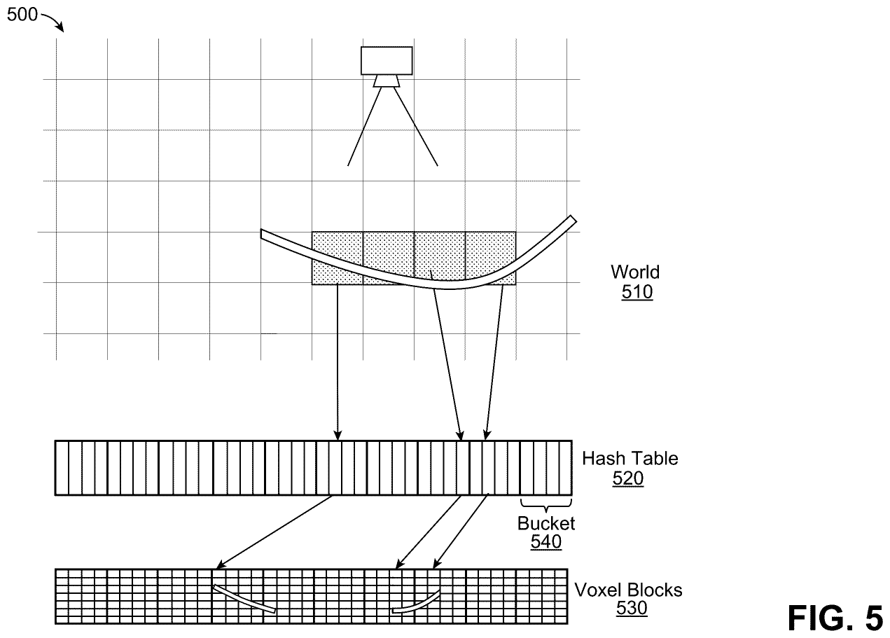

FIG. 5 shows an example of a hash map lookup type of volume block representation. In particular, FIG. 5 is a diagram illustrating an example of a hash mapping function 500 for indexing voxel blocks 530 in a volume grid. In FIG. 5, a volume grid is shown with world coordinates 510. Also shown in FIG. 5 are a hash table 520 and voxel blocks 530. In one or more examples, a hash function can be used to map the integer world coordinates 510 into hash buckets 540 within the hash table 520. The hash buckets 540 can each store a small array of points to regular grid voxel blocks 530. Each voxel block 530 contains data that can be used for depth integration.

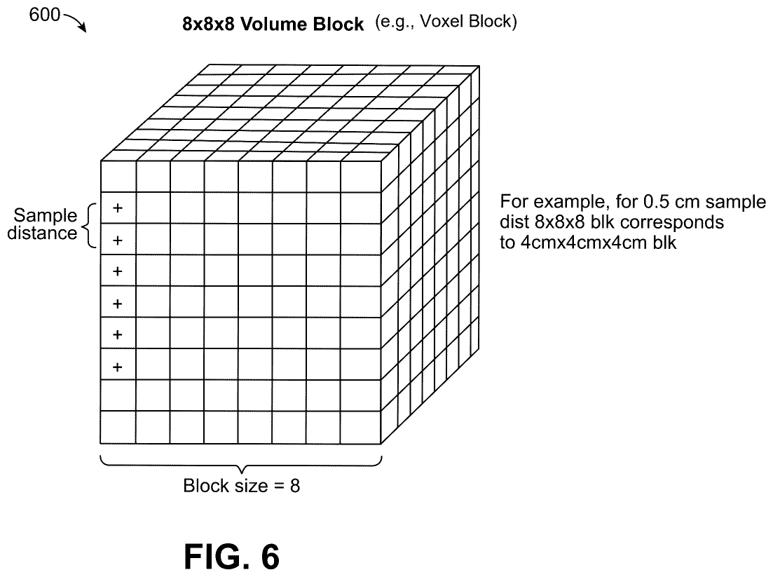

FIG. 6 is a diagram illustrating an example of a volume block (e.g., a voxel block) 600. In FIG. 6, the voxel block 600 is shown to have a block size of eight. For example, a 0.5 centimeter (cm) sample distance for an eight by eight by eight voxel block can correspond to a four cm by four cm by four cm voxel block. That is, the voxel block 600 includes a 3D lattice of 512 voxels, the voxels arranged so that the voxel block 600 has a width of 8 voxels, a length of 8 voxels, and a height of 8 voxels.

In one or more examples, each voxel block (e.g., voxel block 600) can contain or store truncated signed distance function (TSDF) samples and a weight. In some cases, each voxel can also contain or store color values (e.g., red-green-blue (RGB) values). TSDF is a function that measures the distance d of each pixel from the surface of an object to the camera. A voxel block with a positive value for d can indicate that the voxel block is located in front of a surface, a voxel block with a negative value for d can indicate that the voxel block is located inside (or behind) the surface, and a voxel block with a zero value for d can indicate that the voxel block is located on the surface. The distance d is truncated to [−1, 1], for example based on Equation (1) below:

$$tsdf = \{ \begin{matrix}- 1 , & if d \leq - ramp \\ \frac{d}{ramp} , & if - ramp < d < ramp \\ 1 , & if d \geq ramp\end{matrix} \} \qquad Equation ( 1 )$$

$$sample \cdot tsdf = ( \frac{sample \cdot weight * sample \cdot tsdf + tsdf}{sample \cdot weight + 1} )$$

A TSDF integration or fusion process can be employed that updates the TSDF values and weights with each new observation from the sensor (e.g., camera).

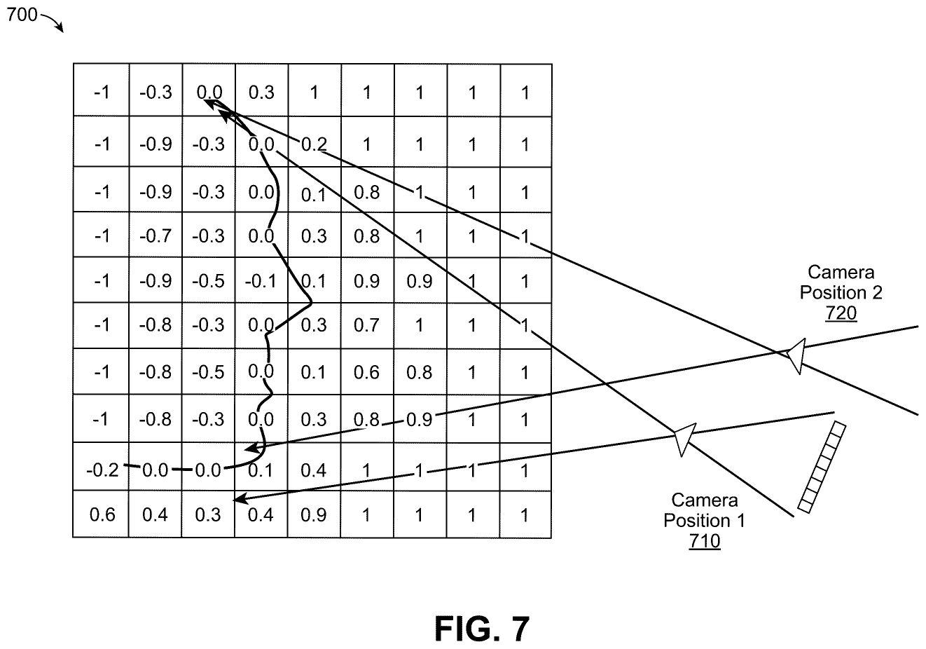

FIG. 7 is a diagram illustrating an example of a TSDF volume reconstruction 700. In FIG. 7, a voxel grid including a plurality of voxel blocks is shown. A camera is shown to be obtaining images of a scene (e.g., person's face) from two different camera positions (e.g., camera position 1 710 and camera position 2 720). During operation for TSDF, for each new observation (e.g., image) from the camera (e.g., for each image taken by the camera at a different camera position), the distance (d) of a corresponding pixel of each voxel block within the voxel grid can be obtained. The distance (d) value can be truncated by comparing a threshold value (e.g., referred to as a ramp) to derive a current TSDF value, and the current TSDF value can be integrated to the TSDF volume, such as by using a weighted averaging (e.g., as shown in equation 1 above). The TSDF values (and in some cases color values) can be updated in the global memory. In FIG. 7, the voxel blocks with positive values are shown to be located in front of the person's face, the voxel blocks with negative values are shown to be located inside of the person's face, and the voxel blocks with zero values are shown to be located on the surface of the person's face.

As previously mentioned, in 3DR, 3D scenes are represented using a 3D volume of points called voxel blocks. Typically, each voxel block carries implicit surface information (e.g., in the form of a TSDF value and a weight for depth integration). The TSDF value is a measure of distance of the voxel block from a surface. The weight is a measure of the reliability of the TSDF value. In some cases, a TSDF weight may be estimated using various approaches, such as a simple counter (e.g., a binary weight, such as 1 or 0), based on a depth range, or from a confidence of the depth predictions. In some cases, a block selection algorithm can select a block if at least one depth pixel is determined to be located in the block. In such cases, there may be no need for a counter and thresholding, or a block can be selected if a counter is equal to 1.

A 3DR system can utilize a sequence of depth maps of a scene with their corresponding 6 DoF poses as an input. The depth maps may be generated using deep learning (DL), non-DL, and/or other depth estimation algorithms or methods. A 3D space of the scene may be uniformly sampled along the X, Y, and Z directions. The 3D space may be divided into fixed size volumes (e.g., block volumes with a fixed number of samples).

A 3DR system generally consists of three stages, which include block selection, integration, and surface extraction. During block selection, all of the blocks that have surfaces or are located close to a surface may be selected. These blocks may then be allocated into memory. In block integration, all voxel blocks within a block volume may be iterated over and an updated TSDF value weight can be calculated. In surface extraction, marching cubes may be used to determine triangular surfaces in the blocks.

In block selection, depth pixels may be iterated over to unproject them to a 3D space and determine where they lie within the 3D space using intrinsic and extrinsic camera parameters. Usually, a hash map is employed for block selection. A hash map is an unordered map, which includes a listing of blocks (e.g., including block indices of the blocks) that have a surface. The hash map may include a corresponding counter for each of the blocks that maintains a count of the number of times depth pixels lie within the particular block. A threshold (e.g., threshold value or number) may be used to select all the blocks that have depth pixels lie within them for more than the threshold number of times. The selected blocks may then be integrated.

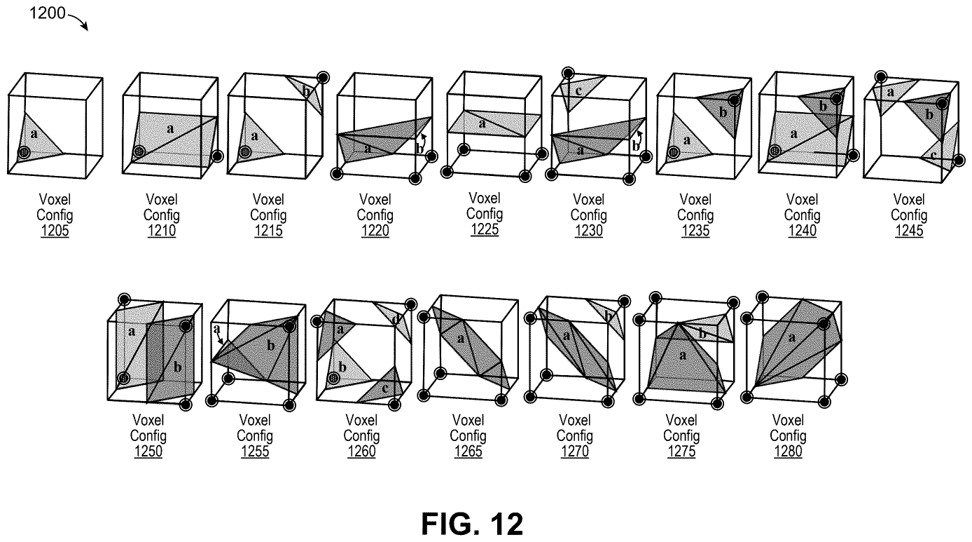

As previously mentioned, 3D surface reconstruction (3DR) is a fundamental task to understand the geometry of a 3D scene, which can be used for various different use cases, including, but not limited to, plane detection, obstacle avoidance, and occlusion rendering. Since 3DR involves processing the 3D space, the compute requirements can increase rapidly due to large amounts of data being processed as compared with 2D applications. Due to these large compute requirements, commercial solutions typically employ traditional computer vision to compute TSDFs as 3D representations from 2D depth images (e.g., as described in the description of FIGS. 6 and 7). By breaking down the 3D space into blocks (e.g., voxel blocks, such as shown in FIG. 4), TSDF computation may be accelerated on hardware platforms. In order to retrieve the geometry needed by down-stream applications, a triangular mesh needs to be extracted from the TSDF representation (e.g., by using a marching cube algorithm, which is described in the description of FIG. 12). This mesh extraction is expensive in terms of compute, bandwidth, and memory, and can result in a mesh with a large number of vertices and edges to describe surfaces in the 3D scene. End-to-end 3DR is a resource intensive task, and any optimization performed within the pipeline can help to manage the large power demands of 3DR. Therefore, improved systems and techniques for 3D reconstruction that conserves compute and power resources can be useful.

In one or more aspects, the systems and techniques provide efficient block-based 3D reconstruction system with mesh hysteresis and simplification. In one or more examples, the systems and techniques provide a framework level optimization for 3DR that employs two engines, which include mesh hysteresis (e.g., a mesh hysteresis engine) and mesh simplification (e.g., a mesh simplification engine).

In one or more examples, the objective of mesh hysteresis is to ensure that whenever the mesh is not changing considerably (e.g., from a previous time to a current time), the previous mesh is retained. By retaining the previous mesh, stability in the generated mesh will be introduced and the workload of the remainder of the pipeline can be reduced. When primarily focusing on edge devices, the mesh is typically reconstructed in a block-wise manner, and the mesh hysteresis engine can identify a block or blocks in which a degree of change does not exceed a set threshold. To achieve this, mesh hysteresis can operate on top of various 3D representations. For instance, in the existing 3DR framework, the mesh hysteresis can either operate on TSDF values or on the 3D mesh itself. In one or more examples, there is no restriction on the 3D mesh that is fed to the mesh hysteresis (e.g., the mesh extracted by the marching cube algorithm can be further processed, such as to be simplified).

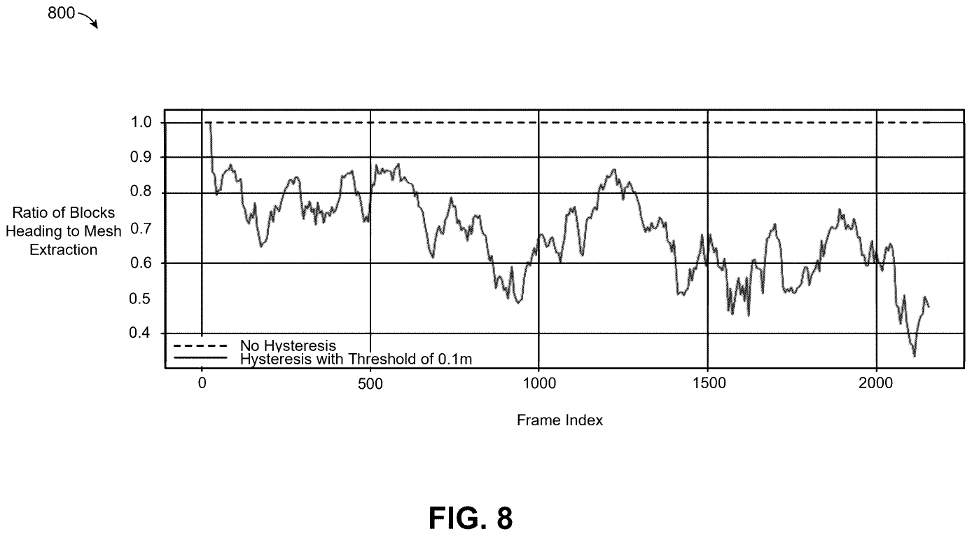

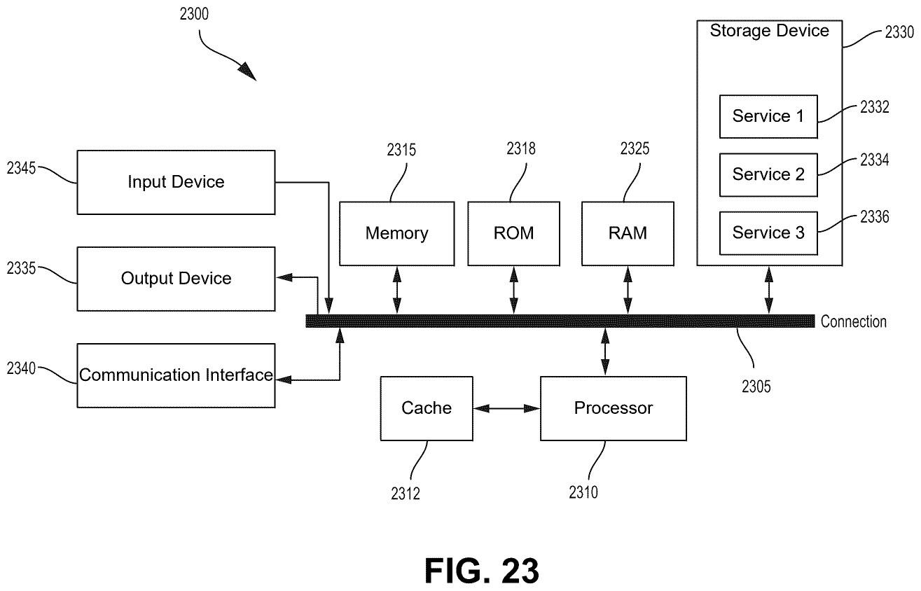

FIG. 8 shows example ratios of blocks (e.g., voxel blocks) selected, based on mesh hysteresis, to be passed to mesh extraction (e.g., surface extraction). In particular, FIG. 8 is a graph 800 illustrating examples of ratios of blocks passed to mesh extraction, where the ratios of the blocks are determined based on mesh hysteresis. The graph 800 of FIG. 8 shows that, when employing mesh hysteresis, less than all blocks (e.g., much less than 100 percent of the blocks in the example of FIG. 8) will be passed to mesh extraction, which can conserve compute and power resources. For instance, rather than working with all blocks (100% of the total blocks), hysteresis can allow a system to operate using fewer numbers of blocks (smaller ratios). The mesh hysteresis engine can select blocks to send to mesh extraction based on the blocks changing (e.g., from a previous time to a current time) exceeding a threshold (e.g., a TSDF threshold amount of change). In some aspects, the threshold (the TSDF threshold among of change) can be provided with a tangible unit and physical meaning attached to it, as it can demonstrate a shift or change of the 3D mesh. For instance, a user can provide user input (e.g., via a user interface, such as the input device 2345 of FIG. 23) specifying the threshold value. In one illustrative example, the threshold can be set to three millimeters, five millimeters, one centimeter, two centimeters, or other value. In some cases, the threshold value can be translated to another value, such as a value corresponding to a change in TSDFs. As the threshold is increased, fewer numbers of blocks will be selected. Similarly, as the threshold is decreased, a greater number of blocks will have a chance to exceed the smaller value and thus to be selected for surface re-extraction.

In the graph 800 of FIG. 8, the x-axis denotes a frame index (e.g., the illustrative example in FIG. 8 includes a frame index ranging from 0 to 2000; any other suitable frame index may be used in other examples), and the y-axis denotes the ratio of blocks heading to mesh extraction (e.g., the illustrative example in FIG. 8 includes a ratio ranging from 0.4, which is forty percent of the total number of blocks, to 1.0, which is 100 percent of the total number of blocks; other ratios of blocks can be used in other examples). Depending on the input data, how a user using a device (e.g., wearing an XR device) moves throughout a scene, how long the scan takes, etc., the properties of the cameras and other parameters can be different than those illustrated in the graph 800.

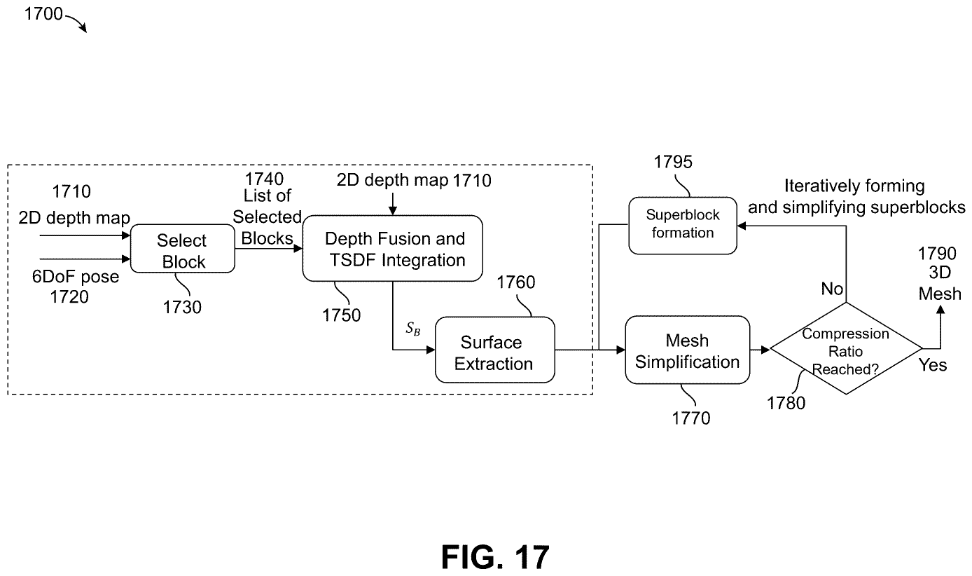

In one or more examples, the goal of the mesh simplification engine is to describe the extracted surfaces with a minimum number of triangles (e.g., a minimum number of vertices and edges), while preserving surface details. When minimizing the number of triangles, redundancies in the recovered geometry (e.g., redundant triangles) can be avoided, which can lead to a power and bandwidth savings, particularly for edge devices. Moreover, the minimized number of triangles can impact the downstream use cases that require a 3D mesh. For instance, for the 2D rendering speed for a user device's display (e.g., a mobile device display), a fewer number of triangles can translate to a higher refresh rate. In one or more examples, the descriptions of FIGS. 17, 18, and 19 describe details of examples of mesh simplification using adaptive block fusion.

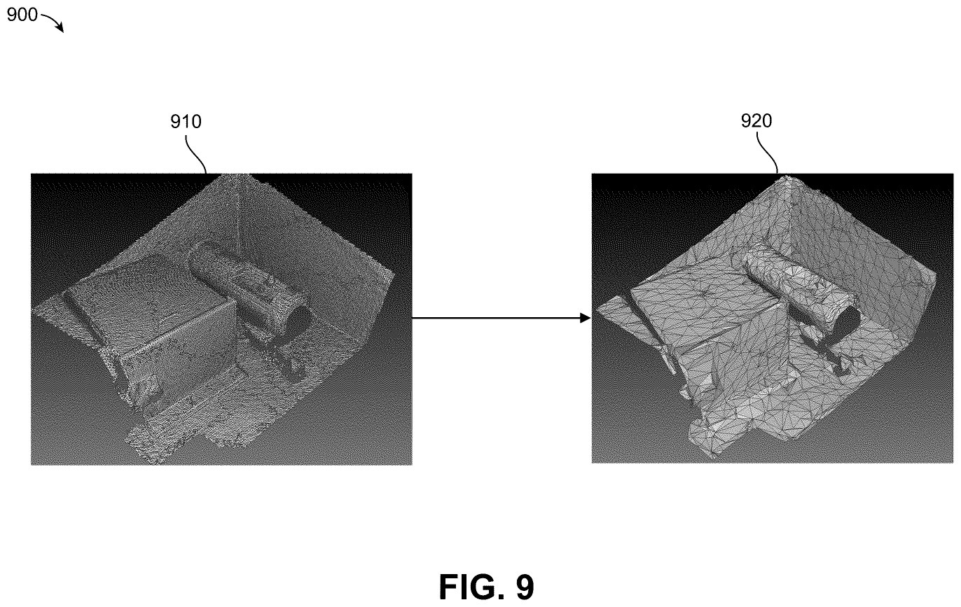

FIG. 9 shows an example of a 3D mesh being simplified by the mesh simplification engine. In particular, FIG. 9 is a diagram illustrating an example 900 of a 3D mesh, generated from a 3D structure, being simplified based on mesh simplification. In FIG. 9, an image 910 shows an example of a 3D mesh generated (e.g., by mesh extraction or surface extraction) based on a 3D structure. The 3D mesh in image 910 is shown to include a large number of triangles with vertices and edges. In one or more examples, the 3D mesh in image 910 can be passed to the mesh simplification engine to generate the 3D mesh shown in image 920. The 3D mesh in image 920 is shown to have a smaller number (e.g., a minimum number) of triangles to represent the 3D structure, while preserving the details of the 3D structure.

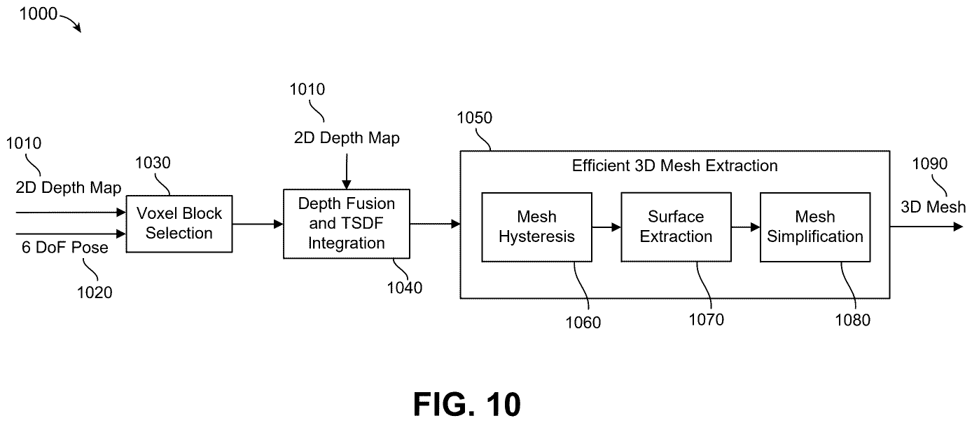

In one or more examples, the systems and techniques provide multiple configurations of mesh hysteresis and mesh simplification for efficient block-based 3DR. FIG. 10 shows an example of a first configuration of mesh hysteresis and mesh simplification for efficient block-based 3DR. In particular, FIG. 10 is a diagram illustrating an example of a configuration of a process 1000 for mesh hysteresis and mesh simplification for efficient block-based 3DR, where the mesh hysteresis is performed at the beginning of efficient 3D mesh extraction. In FIG. 10, the configuration of the process 1000 is shown to include a voxel block selection engine 1030, a depth fusion and TSDF integration engine 1040, and an efficient 3D mesh extraction engine 1050. The efficient 3D mesh extraction engine 1050 is shown to include a mesh hysteresis engine 1060, followed by a surface extraction engine 1070, and followed by a mesh simplification engine 1080.

In FIG. 10, the process 1000 may be performed using a 3D reconstruction system. The 3D reconstruction system can receive a depth map 1010 of a scene, which may be an image that includes a respective depth value for each pixel of the image. The depth map 1010 may be considered two-dimensional (2D), given that the depth map 1010 may be a 2D plane of set of depth values arranged across a 2D plane. The depth map 1010 may be captured by a capture device, and may represent depth values from the perspective of the capture device and based on a pose 1020 (e.g., position and/or orientation) of the capture device. The 3D reconstruction system can also receive the pose 1020 of the capture device (e.g., that captures the depth map 1010), which may include a position (e.g., longitude, latitude, altitude) and/or orientation (e.g., pitch, yaw, roll) of the capture device. In some examples, the capture device may be an XR device (e.g., a headset and/or head mounted display (HMD) device), a mobile handset, a phone, a wireless communication device, or a combination thereof. The pose 1010 may be a 6 degrees of freedom (6DoF) pose, a 3 degrees of freedom (3DoF) pose, or another type of pose, for instance depending on the types of pose sensor(s) (e.g., accelerometer(s), gyroscope(s), gyrometer(s), positioning receiver(s), inertial measurement unit(s), or combination(s) thereof) that the capture device includes.

The 3D reconstruction system can process the depth map 1010 and the pose 1020 using the voxel block selection engine 1030, the depth fusion and TSDF integration engine 1040, and the efficient 3D mesh extraction engine 1050 to generate a 3D mesh 1090 of the scene. More specifically, the 3D reconstruction system can process the depth map 1010 and the pose 1020 using the voxel block selection engine 1030 to identify which blocks of voxels (e.g., block 600 of 512 voxels) that make up the scene includes at least one depth pixel in the depth map 1010, with the origin and the direction of the depth values of the depth map 1010 being identified by the pose 1020. The voxel block selection engine 1030 can select the voxel blocks that include at least one depth pixel, and in some cases, that include at least a threshold amount of depth pixels. In an illustrative example, the voxel block selection engine 1030 (by the 3D reconstruction system) may return the 10 indices to 10 different blocks.

The voxel block selection engine 1030 can also identify previous truncated signed distance function (TSDF) values for specific points in the depth map 1010 and/or in the selected voxel blocks (e.g., that were selected via the voxel block selection engine 1030). The TSDF value for a particular point denotes the distance of the particular point to the closest surface in the 3D mesh representation of the scene. For instance, if a point lies on a surface in the 3D mesh representation of the scene, the TSDF value for that point is zero. However, if a point lies a distance away from the nearest surface in the 3D mesh representation of the scene, the TSDF value for that point is non-zero. In some examples, a sign of a TSDF value (e.g., whether the TSDF value is positive or negative) can indicate which side of a surface the point is on. In some examples, if the point is on the outside of a surface (e.g., the outside of an object that the surface is a part of), then the TSDF value is positive, while if the point is on the inside of the surface (e.g., the inside of the object that the surface is a part of), then the TSDF value is negative.

In some examples, the voxel block selection engine 1030 can specifically select voxel blocks that are likely to include surfaces in the 3D mesh representation of the scene. In some examples, as noted above, to do this, the voxel block selection engine 1030 can select voxel blocks that include at least a threshold amount of points from the depth map 1010 (e.g., at least one point, or at least a threshold number of points where the threshold is greater than one). In some examples, the voxel block selection engine 1030 can select voxel blocks for which the previous TSDF values are within a threshold distance of zero.

The depth fusion and TSDF integration engine 1040 of the 3D reconstruction system can receive, as its inputs, the depth map 1010, the voxel blocks selected by the voxel block selection engine 1030, the previous TSDF values identified by the voxel block selection engine 1030, and/or the pose 1310. As part of the depth fusion and TSDF integration engine 1040, the 3D reconstruction system can summon the blocks for which the voxel block selection engine 1030 returned indices. The 3D reconstruction system can update and/or integrate the TSDF values for the points within those voxel blocks (e.g., points from the depth map 1010, and/or points corresponding to specific voxels within the voxel blocks). As part of the depth fusion and TSDF integration engine 1040, the 3D reconstruction system can thus generate updated TSDF values for the points. In some examples, during operation of the depth fusion and TSDF integration engine 1040, the 3D reconstruction system can continue to keep track of the indices identified by the voxel block selection engine 1030.

For the voxel blocks selected by the voxel block selection engine 1030 (e.g., for which the voxel block selection identified indices), the efficient 3D mesh extraction engine 1050 can perform mesh hysteresis using the mesh hysteresis engine 1060, perform surface extraction using the surface extraction engine 1070, and perform mesh simplification using the mesh simplification engine 1080 to compute (e.g., generate) a 3D mesh 1090 representation of the scene and/or write out the 3D mesh 1090 representation of the scene (e.g., into memory).

In the efficient 3D mesh extraction engine 1050, the mesh hysteresis engine 1060 operates on top of the TSDF representation. The mesh hysteresis engine 1060 can compare the new TSDF values (e.g., current TSDF values at time t₁) with the previous TSDF values (e.g., previous TSDF values at time t₀), and can exclude blocks with unchanged TSDF values from being passed to the surface extraction engine 1070 for surface extraction and to the mesh simplification engine 1080 for mesh simplification.

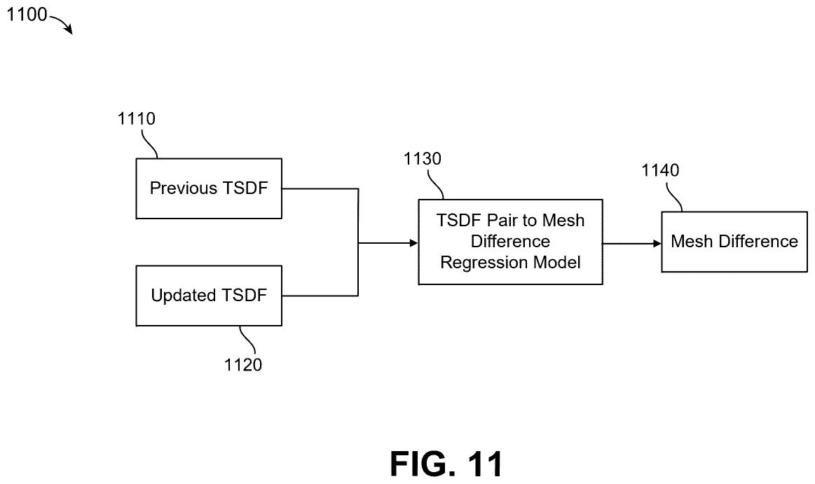

FIG. 11 shows an example process of mesh hysteresis performed by the mesh hysteresis engine 1060 of FIG. 10. In particular, FIG. 11 is a diagram illustrating an example of a process 1100 for mesh hysteresis performed by the mesh hysteresis engine 1060 of FIG. 10. For the configuration of the process 1000 of FIG. 10, the mesh hysteresis operates on top of the TSDF representation. Assuming that there are two sets of TSDF values (e.g., including one set of TSDF values that corresponds to a previous update (e.g., previous TSDF values 1110), and the other set of TSDF values that corresponds to the most recent update (e.g., updated TSDF values 1120), a hysteresis block (e.g., including a TSDF pair to mesh difference regression model 1130) has a mapping that compares the previous TSDF values 1110 and the updated TSDF values 1120, and tries to estimate the difference of the corresponding two meshes (e.g., where one mesh corresponds to the previous TSDF values 1110 and the other mesh corresponds to the updated TSDF values 1120), where:

$$\hat{d} = f ( {TSDF}_{prev} , {TSDF}_{prev} )$$

where f can be the mapping that can be any possible function (e.g., linear or non-linear, such as a neural network), and \hat{d} can be the estimate of the actual mesh difference 1140.

Currently, there are two main metrics that are employed obtain the actual mesh difference 1140. One metric is a cloud-to-cloud (C2C) distance calculation. For the C2C distance calculation, triangular meshes are a set of points (e.g., vertices) that are connected by edges to form the triangles. To compute the C2C distance metric, each of the vertices in one mesh can be taken, and then the smallest distance to the vertices in the other mesh can be computed. This calculation can be quite involved, especially if the size of the meshes is large. For each vertex, all the distances to vertices in the other mesh need to be computed, and the minimum can be chosen, which will require sorting.

Another metric is a cloud-to-mesh (C2M) distance calculation. The C2M distance calculation is similar to the C2C distance calculation, except that for each vertex in one mesh, the smallest distance to the triangles in the other mesh needs to be calculated. Therefore, the C2M distance metric is computationally expensive. For this reason, the mesh hysteresis engine 1060 of FIG. 10 can estimate these values via the mapping of f from the TSDFs.

Since the mesh hysteresis engine 1060 performs an estimation, it can be expected that the computed \hat{d} is less accurate than as computed by the C2C distance metric or by the C2M distance metric. However, computationally, performing the comparison of TSDF values is more advantageous as TSDF values are already ordered in a grid, which can be easily compared.

After the mesh hysteresis engine 1060 has determined the mesh difference 1140, the mesh hysteresis engine 1060 can identify a block or blocks in which a degree of change does not exceed a set threshold (e.g., a difference threshold). The mesh hysteresis engine 1060 can pass a block or blocks, which have a degree of change that does exceed the set threshold (e.g., a difference threshold), to the surface extraction engine 1070.

The surface extraction engine 1070 can use a marching cube algorithm (e.g., described in the description of FIG. 12) to extract the surfaces from the block or blocks to generate a 3D mesh representation (e.g., an unsimplified mesh). The extracted surfaces can be passed to the mesh simplification engine 1080 to simplify (e.g., as illustrated in FIG. 9) the extracted surfaces to generate a 3D mesh 1090 (e.g., a simplified mesh).

In one or more aspects, during operation of the of the process 1000 of FIG. 10 for 3D reconstruction of a scene, one or more processors (e.g., of the voxel block selection engine 1030) can select a plurality of voxel blocks for the scene based on depth data 1010 and pose data 1020 indicative of a perspective of the depth data 1010. One or more processors (e.g., of the depth fusion and TSDF integration engine 1040) can generate, based on at least one of the depth data 1010 or the pose data 1020, a respective 3D representation value for each voxel block of the plurality of voxel blocks. One or more processors (e.g., of the mesh hysteresis engine 1060) can compare each of the respective 3D representation values with a corresponding respective previous 3D representation value to estimate a distance difference for each voxel block of the plurality of voxel blocks. The one or more processors (e.g., of the mesh hysteresis engine 1060) can determine, based on the distance difference being greater than a distance threshold (e.g., five millimeters, six millimeters, ten millimeters, three centimeters, four centimeters, five centimeters, etc., or other such distance values), one or more voxel blocks of the plurality of voxel blocks. For example, the one or more processors (e.g., of the mesh hysteresis engine 1060) can identify one or more voxel blocks of the plurality of voxel blocks having a distance difference greater than the distance threshold. In some aspects, the value used for the distance threshold can depend on a desired accuracy of the mesh (e.g., an accuracy indicated by a user based on user input provided via a user interface, such as the input device 2345 of FIG. 23), how fine the scale of the mesh is (e.g., based on sample distance), how large the blocks are (e.g., based on block size), how much compute is available on a given device, any combination thereof, and/or other factors. One or more processors (e.g., of the surface extraction engine 1070) can generate a 3D mesh (e.g., an unsimplified 3D mesh) based on the one or more voxel blocks of the plurality of voxel blocks. One or more processors (e.g., of the mesh simplification engine 1080) can generate a simplified 3D mesh (e.g., 3D mesh 1090) based on the 3D mesh (e.g., the unsimplified 3D mesh).

In one or more examples, the respective 3D representation values can be TSDF values or point cloud values. In some examples, the TSDF values can be generated based on deep-learning that operates on one or more RGB images of the scene and the pose data 1020. In one or more examples, the 3D mesh (e.g., the unsimplified 3D mesh) can be generated based on a marching cube algorithm (e.g., as shown in FIG. 12). In some examples, the simplified 3D mesh (e.g., 3D mesh 1090) can be generated based on fusing one or more triangles together within the 3D mesh.

In one or more aspects, the mesh hysteresis performed by the mesh hysteresis engine 1060 is efficient due to the well-defined structure of TSDFs. In some examples, the mesh hysteresis performed by the mesh hysteresis engine 1060 allows for a reduction in the workload of the surface extraction engine 1070 and the mesh simplification engine 1080, due to the exclusion of unchanged blocks. For the mesh hysteresis performed by the mesh hysteresis engine 1060, depending upon the compute resources available, at run time, a hysteresis threshold can be selected to control the computational load of the surface extraction engine 1070 and the mesh simplification engine 1080.

FIG. 12 shows an example of surface extraction using a marching cube algorithm. In particular, FIG. 12 is a conceptual diagram 1200 illustrating representations of surface extraction and mesh generation at a voxel level. Using the marching cube algorithm, surface extraction (e.g., performed by the surface extraction engine 1070, 1370, 1570) can be performed one voxel at a time. Each voxel is a cube having eight corners. The eight vertices 1210 of the polygon 1205 (e.g., cube) A, B, C, D, E, F, G, and H of FIG. 12 are examples of the eight corners of a voxel. Each of the eight corners is a point having its own TSDF value. The TSDF value for a point may be positive, negative, or zero. Based on whether the TSDF values for the corners of the voxel are positive, negative, or zero, the corresponding surface(s) that best fit that particular voxel may change. Assuming the TSDF value for each corner is either positive or negative, a given voxel can have 2⁸=256 different surface configurations.

If all of the corners of the voxel have positive TSDF values, this indicates that the entirety of the voxel is outside of the surface, so no surface intersects with that voxel. Similarly, all of the corners of the voxel have negative TSDF values, this indicates that the entirety of the voxel is inside of the surface, so again, no surface intersects with that voxel. Thus, those two voxel configurations represent voxels with no surfaces in them. This leaves 256−2=254 configurations of voxels for which a surface intersects with the voxel. Depending on which corners are positive or negative, these 254 voxel configurations can be represented by 16 different voxel configurations, including voxel configuration 1205, voxel configuration 1210, voxel configuration 1215, voxel configuration 1220, voxel configuration 1225, voxel configuration 1230, voxel configuration 1235, voxel configuration 1240, voxel configuration 1245, voxel configuration 1250, voxel configuration 1255, voxel configuration 1260, voxel configuration 1265, voxel configuration 1270, voxel configuration 1275, and the voxel configuration 1280.

These 16 different voxel configurations may be rotated depending on which corners have positive TSDF values vs. which corners have negative TSDF values. The surface extraction engine 1070, 1370, 1570 can compute the zero crossings along the edges of the voxels based on the TSDF values of the corners. For instance, if a first corner have a positive TSDF value and a second corner has a negative TSDF value, then a zero crossing of the surface (e.g., the point at which the TSDF value is zero) occurs somewhere along the edge of the voxel between the first corner and the second corner. The zero crossing can be estimated differently depending on the respective magnitudes (e.g., absolute values) of the TSDF values of the two corners, for instance so that the zero crossing is closer to whichever corner has the lower magnitude (e.g., absolute value) of its TSDF value. The zero crossing location along the edge of the voxel indicates where a given surface intersects with the voxel.

The voxel configurations 1205-1280 are illustrated in FIG. 12 with certain corners of the voxel being represented by large dark dots with circles around them (referred to as “circled dots” below), and other corners lacking the circled dots. The dots (within the circled dots) are illustrated as black where unoccluded by surfaces, or shaded with a halftone pattern where occluded by surfaces. The corners represented by the large-circled dots have TSDF values with a different sign than the TSDF values of the corners that lack the circled dots. For instance, in a first illustrative example, the corners illustrated with circled dots have negative TSDF values, while the corners that lack the circled dots have positive TSDF values. In a second illustrative example, the corners illustrated with circled dots have positive TSDF values, while the corners that lack the circled dots have negative TSDF values. The surface(s) that intersect with a given voxel are illustrated as translucent grey surfaces, with each surface made up of one or more triangles. In situations where a voxel has two or more intersecting surfaces that are close to one another and/or overlap from the perspective illustrated in FIG. 12, the surfaces intersecting the voxel (and that are close to one another) are shaded using two different shades of grey (one lighter and one darker) to help distinguish the different surfaces. Furthermore, the surfaces intersecting the voxel are labeled with letters (e.g., a, b, c, d, and so forth). Voxels with only one intersecting surface are illustrated with that surface labeled “a”; voxels with two intersecting surfaces are illustrated with those surface labeled “a” and “b,” respectively; voxels with three intersecting surfaces are illustrated with those surface labeled “a,” “b,” and “c” respectively; and so forth. In some examples, a given voxel configuration can look the same if the respective TSDF values of all of the corners flip signs. For instance, the position of the surface intersecting the voxel configuration 1205 can be the same regardless of whether (a) the corner with the circled dot has a negative TSDF value and the other corners without the circled dots have positive TSDF values, or (b) the corner with the circled dot has a positive TSDF value and the other corners without the circled dots have negative TSDF values.

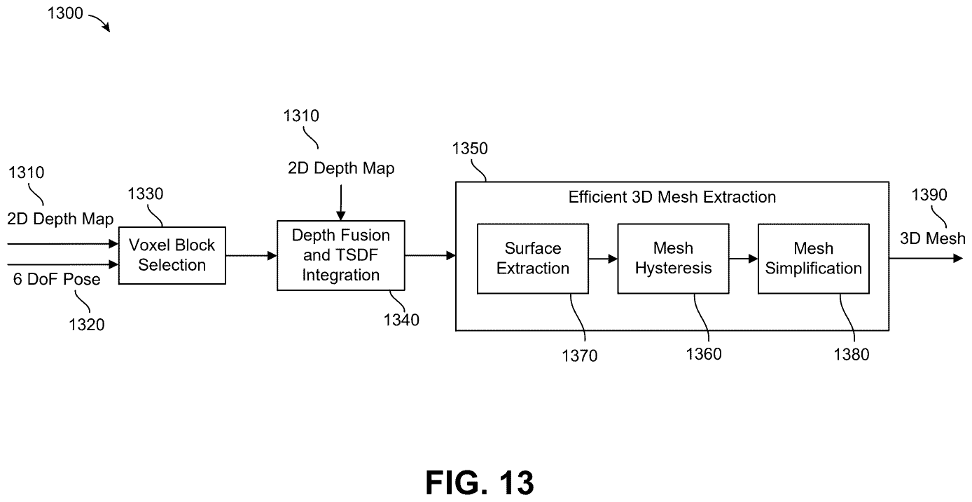

In one or more aspects, FIG. 13 shows an example of a second configuration of mesh hysteresis and mesh simplification for efficient block-based 3DR. In particular, FIG. 13 is a diagram illustrating an example of a configuration of a process 1300 for mesh hysteresis and mesh simplification for efficient block-based 3DR, where the mesh hysteresis is performed on an unsimplified 3D mesh. In FIG. 13, the configuration of the process 1300 is shown to include a voxel block selection engine 1330, a depth fusion and TSDF integration engine 1340, and an efficient 3D mesh extraction engine 1350. The efficient 3D mesh extraction engine 1350 is shown to include a surface extraction engine 1370, followed by a mesh hysteresis engine 1360, and followed by a mesh simplification engine 1380.

In FIG. 13, the process 1300 may be performed using a 3D reconstruction system. The 3D reconstruction system can receive a depth map 1310 of a scene, which may be an image that includes a respective depth value for each pixel of the image. The depth map 1310 may be captured by a capture device, and may represent depth values from the perspective of the capture device and based on a pose 1320 (e.g., position and/or orientation) of the capture device. The 3D reconstruction system can also receive the pose 1320 of the capture device (e.g., that captures the depth map 1310), which may include a position (e.g., longitude, latitude, altitude) and/or orientation (e.g., pitch, yaw, roll) of the capture device.

The 3D reconstruction system can process the depth map 1310 and the pose 1320 using the voxel block selection engine 1330, the depth fusion and TSDF integration engine 1340, and the efficient 3D mesh extraction engine 1350 to generate a 3D mesh 1390 of the scene. The voxel block selection engine 1330 and the depth fusion and TSDF integration engine 1340 operate similarly to the voxel block selection engine 1030 and the depth fusion and TSDF integration engine 1040, respectively, of FIG. 10.

For the voxel blocks selected by the voxel block selection engine 1330 (e.g., for which the voxel block selection identified indices), the efficient 3D mesh extraction engine 1350 can perform surface extraction using the surface extraction engine 1370, perform mesh hysteresis using the mesh hysteresis engine 1360, and perform mesh simplification using the mesh simplification engine 1380 to compute (e.g., generate) a 3D mesh 1390 representation of the scene and/or write out the 3D mesh 1390 representation of the scene (e.g., into memory).

In the efficient 3D mesh extraction engine 1350, the surface extraction engine 1370 can use a marching cube algorithm (e.g., described in the description of FIG. 12) to extract the surfaces from the selected blocks to generate an unsimplified 3D mesh representation, the mesh hysteresis engine 1360 operates on the unsimplified 3D mesh produced by the surface extraction engine 1370.

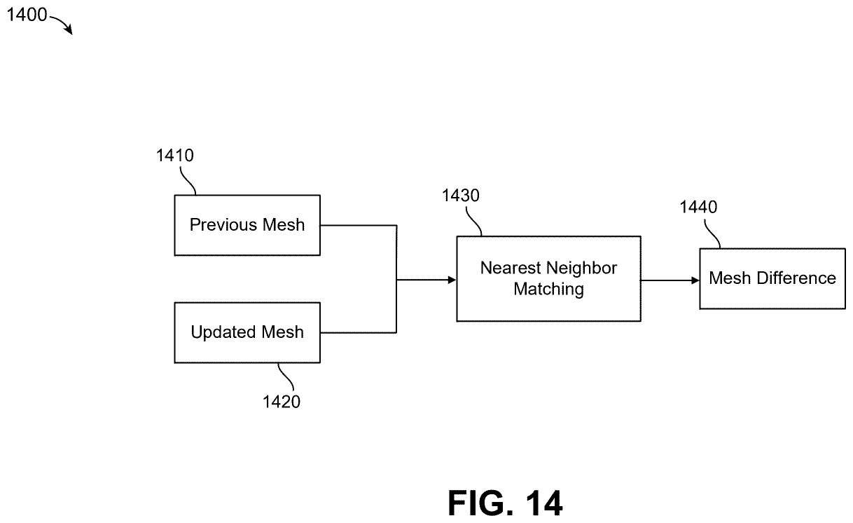

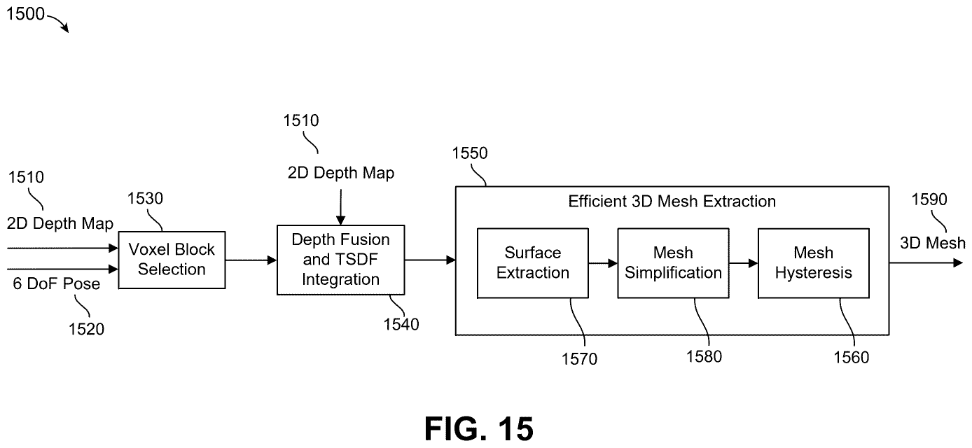

FIG. 14 shows an example process of mesh hysteresis performed by the mesh hysteresis engine 1360 of FIG. 13. In particular, FIG. 14 is a diagram illustrating an example of a process 1400 for mesh hysteresis performed by the mesh hysteresis engine 1360 of FIG. 13 (as well as by the mesh hysteresis engine 1560 of FIG. 15). For the configuration of the process 1300 of FIG. 13, the mesh hysteresis operates on top of the unsimplified 3D mesh. For the configuration of the process 1500 of FIG. 15, the mesh hysteresis operates on top of the simplified 3D mesh.

In these processes 1300, 1500, the mesh hysteresis engine 1360, 1560 operates on the 3D mesh, either unsimplified or simplified, the mesh hysteresis engine 1360, 1560 can compare the 3D mesh corresponding to the previous update (e.g., previous mesh 1410) and the mesh corresponding to the most recent update (e.g., updated mesh 1420). The mesh hysteresis engine 1360, 1560 can calculate either C2C distance or C2M distance metrics, which are both quite accurate, but computationally more involved as they require finding a nearest vertex of a triangle (e.g., nearest neighbor matching 1430) to determine the mesh difference 1440. For the process 1300 of FIG. 13, the mesh hysteresis engine 1360 can compare the updated mesh 1420 with the previous mesh 1410 for all of the blocks and, subsequently, can exclude unchanged blocks from being passed to the mesh simplification engine 1380 and discards the updated mesh 1420. The unsimplified 3D mesh of the changed blocks can be passed to the mesh simplification engine 1380 to simplify (e.g., as illustrated in FIG. 9) the extracted surfaces to generate a 3D mesh 1390. Performing the mesh hysteresis on the simplified 3D mesh is easier than on the unsimplified 3D mesh because the simplified 3D mesh has a fewer number of vertices and edges to search among.

In one or more examples, the mesh hysteresis performed by the mesh hysteresis engine 1360 is accurate because it operates on the meshes from which exact change can be calculated. The mesh simplification engine 1380 only processes the changing blocks' meshes, which can reduce the workload.

In one or more aspects, during operation of the process 1300 of FIG. 13 for 3D reconstruction of a scene, one or more processors (e.g., of the voxel block selection engine 1330) can select a plurality of voxel blocks for the scene based on depth data 1310 and pose data 1320 indicative of a perspective of the depth data 1310. One or more processors (e.g., of the surface extraction engine 1370) can generate, based on the plurality of voxel blocks, a 3D mesh (e.g., an unsimplified 3D mesh) comprising a plurality of vertices. One or more processors (e.g., of the mesh hysteresis engine 1360) can compare each vertex of the plurality of vertices of the 3D mesh (e.g., the unsimplified 3D mesh) with a corresponding respective previous vertex to estimate a distance difference for each vertex of the plurality of vertices of the 3D mesh. The one or more processors (e.g., of the mesh hysteresis engine 1360) can determine, based on the distance difference being greater than a distance threshold, one or more portions of the 3D mesh. For example, the one or more processors (e.g., of the mesh hysteresis engine 1060) can identify one or more portions of the 3D mesh corresponding to vertices of the plurality of vertices having a distance difference greater than a distance threshold. One or more processors (e.g., of the mesh simplification engine 1380) can generate a simplified 3D mesh (e.g., 3D mesh 1390) based on the one or more portions of the 3D mesh (e.g., the unsimplified 3D mesh).

In one or more aspects, FIG. 15 shows an example of a third configuration of mesh hysteresis and mesh simplification for efficient block-based 3DR. In particular, FIG. 15 is a diagram illustrating an example of a configuration of a process 1500 for mesh hysteresis and mesh simplification for efficient block-based 3DR, where the mesh hysteresis is performed on a simplified 3D mesh. In FIG. 15, the configuration of the process 1500 is shown to include a voxel block selection engine 1530, a depth fusion and TSDF integration engine 1540, and an efficient 3D mesh extraction engine 1550. The efficient 3D mesh extraction engine 1550 is shown to include a surface extraction engine 1570, followed by a mesh simplification engine 1580, and followed by a mesh hysteresis engine 1560.

In FIG. 15, the process 1500 may be performed using a 3D reconstruction system. The 3D reconstruction system can receive a depth map 1510 of a scene, which may be an image that includes a respective depth value for each pixel of the image. The depth map 1510 may be captured by a capture device, and may represent depth values from the perspective of the capture device and based on a pose 1520 (e.g., position and/or orientation) of the capture device. The 3D reconstruction system can also receive the pose 1520 of the capture device (e.g., that captures the depth map 1510), which may include a position (e.g., longitude, latitude, altitude) and/or orientation (e.g., pitch, yaw, roll) of the capture device.

The 3D reconstruction system can process the depth map 1510 and the pose 1520 using the voxel block selection engine 1530, the depth fusion and TSDF integration engine 1540, and the efficient 3D mesh extraction engine 1550 to generate a 3D mesh 1590 of the scene. The voxel block selection engine 1530 and the depth fusion and TSDF integration engine 1540 operate similarly to the voxel block selection engine 1030 and the depth fusion and TSDF integration engine 1040, respectively, of FIG. 10.

For the voxel blocks selected by the voxel block selection engine 1530 (e.g., for which the voxel block selection identified indices), the efficient 3D mesh extraction engine 1550 can perform surface extraction using the surface extraction engine 1570, perform mesh simplification using the mesh simplification engine 1580, and perform mesh hysteresis using the mesh hysteresis engine 1560 to compute (e.g., generate) a 3D mesh 1590 representation of the scene and/or write out the 3D mesh 1590 representation of the scene (e.g., into memory).

In the efficient 3D mesh extraction engine 1550, the surface extraction engine 1570 can use a marching cube algorithm (e.g., described in the description of FIG. 12) to extract the surfaces from the block or blocks to generate a 3D mesh representation (e.g., an unsimplified mesh). The extracted surfaces can be passed to the mesh simplification engine 1580 to simplify (e.g., as illustrated in FIG. 9) the extracted surfaces to generate a 3D mesh (e.g., a simplified mesh). The mesh hysteresis engine 1560 operates on the simplified 3D mesh produced by the mesh simplification engine 1580. Once the simplified mesh is generated, the mesh hysteresis engine 1560 can compare the newly simplified mesh (e.g., updated mesh 1420) to the previously simplified mesh (e.g., previous mesh 1410) to identify the changing and unchanged blocks. The unchanged blocks will be excluded from the flow, and their newly simplified mesh will be discarded.

In one or more examples, the mesh hysteresis performed by the mesh hysteresis engine 1560 will have a significantly reduced workload as it operates on simplified meshes with a much smaller number of vertices and edges and, as such, with less computing resources, the mesh hysteresis can determine an accurate mesh change. In some examples, the mesh simplification can benefit from the neighboring blocks information prior to their exclusion to perform a better simplification (e.g., achieve a higher simplification rate). This higher simplification rate can be important for block-based 3DR, which is typically bounded to the scope of only a single block at a time.

In one or more aspects, during operation of the process 1500 of FIG. 15 for 3D reconstruction of a scene, one or more processors (e.g., of the voxel block selection engine 1530) can select a plurality of voxel blocks for the scene based on depth data 1510 and pose data 1520 indicative of a perspective of the depth data 1510. One or more processors (e.g., of the surface extraction engine 1570) can generate, based on the plurality of voxel blocks, a 3D mesh (e.g., an unsimplified 3D mesh). One or more processors (e.g., of the mesh simplification engine 1580) can generate, based on the 3D mesh (e.g., the unsimplified mesh), a simplified 3D mesh comprising a plurality of vertices. One or more processors (e.g., of the mesh hysteresis engine 1560) can compare each vertex of the plurality of vertices of the simplified 3D mesh with a corresponding respective previous vertex to estimate a distance difference for each vertex of the plurality of vertices of the simplified 3D mesh. The one or more processors (e.g., of the mesh hysteresis engine 1560) can determine, based on the distance difference being greater than a distance threshold, one or more portions of the simplified 3D mesh. For example, the one or more processors (e.g., of the mesh hysteresis engine 1060) can identify one or more portions of the simplified 3D mesh corresponding to vertices of the plurality of vertices having a distance difference greater than a distance threshold. One or more processors (e.g., of the efficient 3D mesh extraction engine 1550) can generate a final 3D mesh (e.g., 3D mesh 1590) based on the one or more portions of the simplified 3D mesh.

In one or more aspects, for the systems and techniques, TDSFs can be employed as the main 3D representations, and the TDSFs can be computed from a pose and input depth maps, as existing commercial solutions typically do so. However, the 3D representation of a general 3DR pipeline can employ different 3D representations. For instance, a TSDF representation can be obtained from a deep-learning based system that operates on RGB images and a pose rather than a 2D depth map. For this example, a framework that uses mesh hysteresis and mesh simplification in tandem can be employed to reduce the overall 3DR workload. In one or more examples, the 3DR system's main 3D representation can be point clouds instead of TSDFs and, as such, the 3D mesh may be obtained from point clouds. For these examples, mesh hysteresis and mesh simplification can be employed to reduce the high computational demands of 3DR. In some examples, a framework may be employed that performs mesh simplification of the computed 3D representation prior to the mesh extraction. The main goal of these examples is to pre-process the obtained 3D representation that results in simpler 3D surfaces.

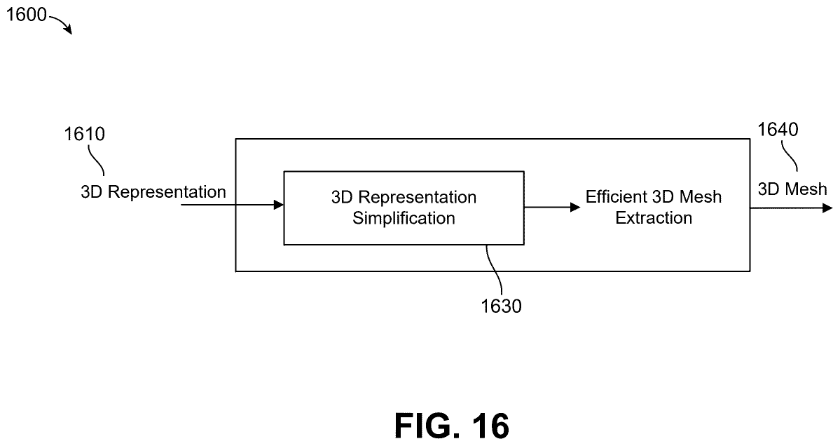

FIG. 16 shows an example of a configuration where a 3D representation simplification is performed to pre-process the 3D representation to generate simpler 3D surfaces. In particular, FIG. 16 is a diagram illustrating an example of a configuration of a process 1600 for 3D representation simplification. In FIG. 16, the configuration of the process 1600 is shown to include an efficient 3D mesh extraction engine 1620 that includes a 3D representation simplification engine 1630.

In FIG. 16, the process 1600 may be performed using a 3D reconstruction system. During operation of the process 1600, a 3D representation 1610 (e.g., TDSF values or point clouds) may be inputted into the 3D representation simplification engine 1630 of the efficient 3D mesh extraction engine 1620. The 3D representation simplification engine 1630 can generate, based on the 3D representation 1610, a 3D mesh 1640 that can include simplified surfaces.

In one or more aspects, as previously mentioned, 3DR deals with processing the geometry of a 3D space. Commercial solutions are mainly based on traditional computer vision to compute TSDFs as a 3D representation from 2D depth images. By breaking the 3D space into blocks, TSDF computation can be substantially increased on hardware platforms. After performing the TSDF calculations, a 3D mesh can be obtained via running a marching cube algorithm (e.g., as shown in FIG. 12). Since the reconstruction of a 3D space is conducted gradually and in a block-wise manner, it is important that the 3D meshes realized from each block form a continuous global mesh. To this end, prior to performance of mesh extraction for each block, it can be ensured that the TSDF values located at the border of two adjacent blocks are identical, resulting in identical vertices that can be later stitched into a continuous mesh. Depending upon where the capturing device is located and in which direction the capturing device is viewing, a number of blocks can be selected, measured depth can be integrated in the respective blocks' TSDF values, and the mesh can be recalculated. With a fixed sample distance and block size, the marching cubes can extract triangles that intersect every cell (e.g., which can include eight TSDF values). The number of triangles produced can be quite large for a standard scene. This large number can result in a high power usage, an increase in bandwidth, delayed rendering, and higher storage needed for any downstream applications.

For a 3D scene, the number of triangles and vertices in the 3D mesh can be reduced without costing any geometric errors. For example, a simple plane may be represented by two triangles at the very best. Since general surface extraction algorithms can represent the surface using many more triangles and vertices, there is need to simplify the 3D meshes.

For a block-based 3DR design, there is a need to perform mesh simplification on a block level instead of on a global mesh, however this poses some serious issues towards mesh continuity. Because the algorithm was designed to take in a global mesh, the algorithm considers a mesh present in a block as global and collapses edges and vertices even on the boundary causing discontinuity. One preliminary solution is to fix the boundaries such that they do not move. However, this solution does not achieve the required compression ratio as compared to the added latency caused by the algorithm.

The hardware has a finite memory to load an input mesh with the corresponding metadata. Accessing the mesh during runtime from external memory can be costly in terms of bandwidth and latency, as the simplification approaches would need to load data from multiple connected triangles and vertices. Since a mesh is a bidirectionally connected graph, a mesh can be loaded only if the mesh fits within the hardware memory.

Using existing simplification algorithms, the systems and techniques can employ a high-level architecture design to simplify the 3D meshes generated from block-based TSDF. The scheme can perform local simplification by adaptively aggregating meshes from local neighborhoods by maintaining continuity on the global mesh and achieving a good simplification rate.

In one or more aspects, mesh simplification algorithms can simplify the mesh assuming the mesh as global mesh without any context, however this causes issues for block-based meshes as it causes discontinuity to the global mesh as block boundaries are moved during simplification. Not allowing the boundaries vertices to participate in simplification can resolve the issue of mesh continuity, however at the same time, it does not lead to a desired compression.

In order to meet the desired compression, the systems and techniques provide an approach to adaptively fuse a block mesh to create superblocks with larger meshes, and to iteratively simplify these superblock block meshes, while keeping the boundaries vertices intact. The approach can start by selecting blocks at the smallest block level and can simplify the selected blocks. As the blocks are simplified, the number of triangles and vertices are reduced. Meshes can then be fused from multiple neighboring blocks to create superblock meshes, which can be passed to the mesh simplification algorithm (e.g., mesh simplification engine 1770 of FIG. 17) located in the next stage.

The hardware has a finite cache and, as such, the hardware can load a fixed number of vertices and triangles as the hardware also needs memory for other metadata needed during simplification (e.g., triangle normal, quadric matrix for a vertex, etc.). Depending upon the hardware limitations, the upper limit for the block fusion can be chosen, and this upper limit can be adapted for different parts of the scene. Overall, the systems and techniques provide a hierarchical approach to block-based mesh simplification for achieving a higher compression, while considering the limitations of loading the block mesh and its metadata into the finite hardware internal cache.

FIG. 17 shows an example process employing mesh simplification using adaptive block fusion. In one or more examples, the mesh simplification engines 1080, 1380, 1580 of FIGS. 10, 13, and 15, respectively, may employ at least a portion of this process for performing mesh simplification. In particular, FIG. 17 is a diagram illustrating an example of a configuration of a process 1700 employing mesh simplification using adaptive block fusion. In FIG. 17, the configuration of the process 1700 is shown to include a voxel block selection engine 1730, a depth fusion and TSDF integration engine 1750, a surface extraction engine 1760, a mesh simplification engine 1770, and a superblock formation engine 1795.

In FIG. 17, the process 1700 may be performed using a 3D reconstruction system. The 3D reconstruction system can receive a depth map 1710 of a scene, which may be an image that includes a respective depth value for each pixel of the image. The depth map 1710 may be captured by a capture device, and may represent depth values from the perspective of the capture device and based on a pose 1720 (e.g., position and/or orientation) of the capture device. The 3D reconstruction system can also receive the pose 1720 of the capture device (e.g., that captures the depth map 1710), which can include a position (e.g., longitude, latitude, altitude) and/or orientation (e.g., pitch, yaw, roll) of the capture device.

The 3D reconstruction system can process the depth map 1710 and the pose 1720 using the voxel block selection engine 1730, the depth fusion and TSDF integration engine 1750, the surface extraction engine 1760, and the mesh simplification engine 1770 to generate a 3D mesh (e.g., 3D mesh 1790) of the scene. The voxel block selection engine 1730 and the depth fusion and TSDF integration engine 1750 operate similarly to the voxel block selection engine 1030 and the depth fusion and TSDF integration engine 1040, respectively, of FIG. 10.

For the voxel blocks selected (e.g., within the list of selected blocks 1740) by the voxel block selection engine 1730 (e.g., for which the voxel block selection identified indices), the surface extraction engine 1760 can perform surface extraction to produce a 3D mesh (e.g., an unsimplified 3D mesh). In one or more examples, the surface extraction engine 1760 can use a marching cube algorithm (e.g., described in the description of FIG. 12) to extract the surfaces from the blocks to generate the 3D mesh (e.g., the unsimplified 3D mesh).

The mesh simplification engine 1580 can perform, based on the 3D mesh (e.g., the unsimplified 3D mesh), mesh simplification to generate a simplified 3D mesh. In one or more examples, the mesh simplification engine 1580 can simplify the extracted surfaces of the 3D mesh to produce the simplified 3D mesh.

After the simplified 3D mesh is generated, at decision box 1780, one or more processors can determine, based on the simplified 3D mesh, whether a hardware limit (e.g., based on a number of triangles in the simplified 3D mesh) and/or desired compression ratio (e.g., a compression ratio threshold, such as 30%, 50%, 60%, etc.) has been reached (e.g., whether the simplified 3D mesh meets the hardware limit and/or desired compression ratio). If the one or more processors determine that the hardware limit and/or desired compression ratio has been reached, the simplified 3D mesh (e.g., 3D mesh 1790) can be outputted.

However, if the one or more processors determine that the hardware limit and/or desired compression ratio has not been reached, the superblock formation engine 1795 can perform adaptive block fusion by fusing meshes of neighboring (e.g., adjacent) blocks together to form superblocks (e.g., superblock meshes).

After the superblock meshes have been formed, the mesh simplification engine 1770 can, based on the superblock meshes, simplify the extracted surfaces of the superblock meshes to produce a further simplified 3D mesh.

After the further simplified 3D mesh is generated, at decision box 1780, one or more processors can determine, based on the further simplified 3D mesh, whether a hardware limit and/or desired compression ratio has been reached (e.g., whether the further simplified 3D mesh meets the hardware limit and/or desired compression ratio). If the one or more processors determine that the hardware limit and/or desired compression ratio has been reached, the further simplified 3D mesh (e.g., 3D mesh 1790) can be outputted.

However, if the one or more processors determine that the hardware limit and/or desired compression ratio has not been reached, the process can repeat where superblocks (e.g., superblock meshes) can continue to be iteratively formed and simplified.

In one or more examples, the mesh simplification using adaptive block fusion approach provides a hardware architecture for mesh simplification to a block based 3DR, ensuring continuity while achieving the desired compression. The process 1700 works towards simplifying the mesh, while maintaining the quality of the mesh. The process 1700 directly works on the block-based mesh structure. The proposed framework can help to reduce the needed bandwidth, can improve rendering, and can require less storage. The process 1700 can also benefit from parallel processing of the blocks and superblocks.

In one or more examples, the goal of mesh simplification using adaptive block fusion is to describe the extracted surfaces with a minimum number of triangles (e.g., a minimum number of vertices and edges), while preserving the surface details. In doing so, redundances in the recovered geometry can be avoided and power and bandwidth conservation can occur, particularly for edge devices. The lesser number of triangles can impact the downstream use cases that require a 3D mesh. For example, a lesser number of triangles can lead to a 2D rendering speed for a user device's display to have a higher refresh rate.

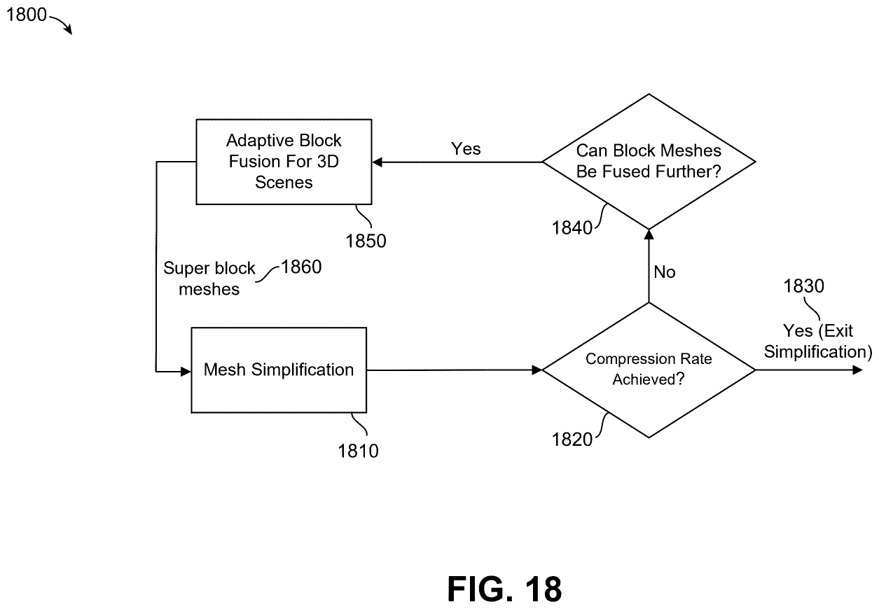

FIG. 18 shows an example of hierarchical mesh simplification using adaptive block fusion. In particular, FIG. 18 is a diagram illustrating an example of a process 1800 for hierarchical mesh simplification using adaptive block fusion. The process 1800 operates in a hierarchical fashion. In FIG. 18, the process 1800 is shown to include a mesh simplification engine 1810 and an adaptive block fusion for 3D scenes engine 1850.

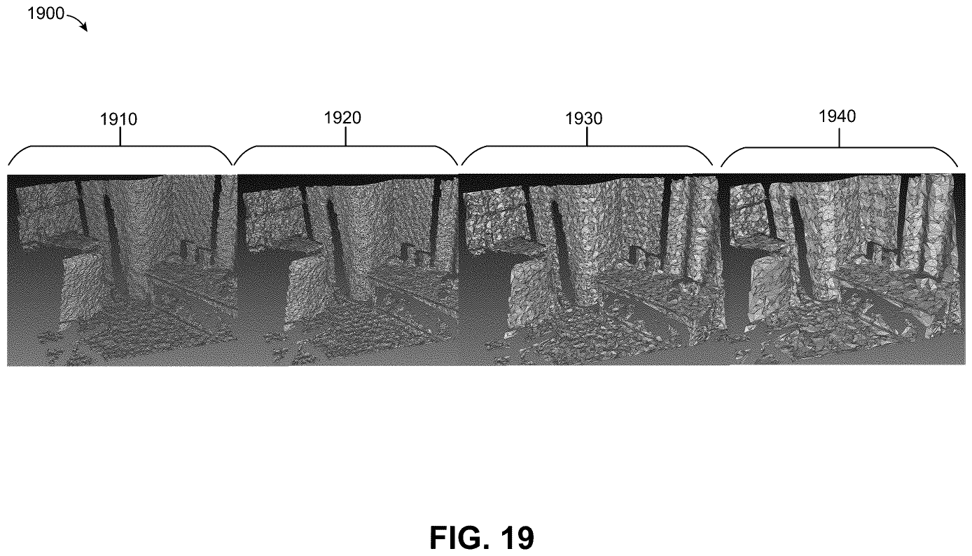

FIG. 19 shows examples of block meshes that may be generated during hierarchical mesh simplification using adaptive block fusion. In particular, FIG. 19 is a diagram illustrating examples 1900 of block meshes that may be generated during hierarchical mesh simplification using adaptive block fusion. FIGS. 18 and 19 will be described in conjunction with each other.

In one or more examples, during operation of the process 1800 of FIG. 18, block meshes (e.g., block-based mesh input for stage-1, as shown in image 1910) may be generated by using a block-based 3DR approach. In one or more examples, the blocks in image 1910 may be size 2×2×2 blocks.

The mesh simplification engine 1810 can simplify the block meshes (e.g., as shown in image 1910) by keeping the boundaries and vertices intact (e.g., which may be essential for continuity of the global mesh) to generate simplified block meshes (e.g., mesh simplification stage-1 output, as shown in image 1920). In one or more examples, the blocks in image 1920 may be size 4×4×4 blocks.

At decision block 1820, one or more processors can determine, based on the simplified block meshes (e.g., as shown in image 1920), whether a hardware limit and/or desired compression ratio has been reached (e.g., whether the simplified block meshes meet the hardware limit and/or desired compression ratio). If the one or more processors determine that the hardware limit and/or desired compression ratio has been reached, mesh simplification can be exited 1830.

However, if the one or more processors determine that the hardware limit and/or desired compression ratio has not been reached, at decision block 1840, one or more processors can determine whether the simplified block meshes (e.g., as shown in image 1920) can be fused further. If the one or more processors determine that the simplified block meshes (e.g., as shown in image 1920) can be fused further, the adaptive block fusion for 3D scenes engine 1850 can perform adaptive block fusion by fusing meshes of neighboring (e.g., adjacent) blocks of the simplified block meshes (e.g., as shown in image 1920) together to form superblocks (e.g., superblock meshes 1860, such as shown in image 1930). In one or more examples, the blocks in image 1930 may be size 8×8×8 blocks. The mesh fusion can be adapted based on the number of vertices and triangles that can be loaded into the mesh simplification hardware.

In one or more examples, the process 1800 can be repeated where the adaptive block fusion for 3D scenes engine 1850 can perform adaptive block fusion by fusing meshes of neighboring (e.g., adjacent) blocks of the superblock meshes 1860 (e.g., as shown in image 1930) together to form superblocks (e.g., superblock meshes, such as shown in image 1940). In one or more examples, the blocks in image 1940 may be size 16×16×16 blocks.

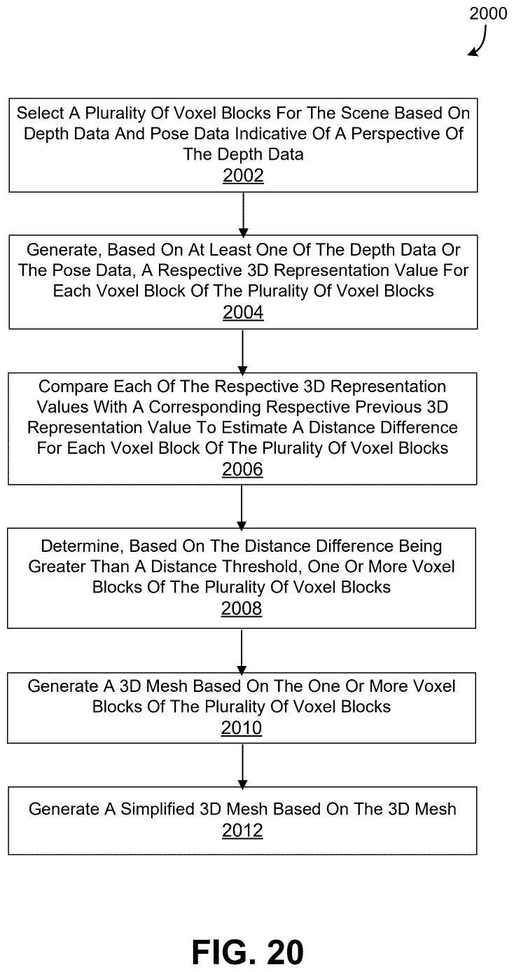

FIG. 20 is a flow chart illustrating an example of a process 2000 for image processing. The process 2000 can be performed by a computing device (e.g., a computing device or computing system 2300 of FIG. 23) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 2000 may be implemented as software components that are executed and run on one or more processors (e.g., processor 2310 of FIG. 23, or other processor(s)). Further, the transmission and reception of signals by the computing device in the process 2000 may be enabled, for example, by one or more antennas and/or one or more transceivers (e.g., wireless transceiver(s)).

At block 2002, the computing device (or component thereof) can select (e.g., using the voxel block selection engine 1030 of FIG. 10) a plurality of voxel blocks for the scene based on depth data (e.g., depth data in the 2D depth map 1010 of FIG. 10) and pose data (e.g., 6 DoF pose data of FIG. 10) indicative of a perspective of the depth data.

At block 2004, the computing device (or component thereof) can generate (e.g., using the depth fusion and TSDF integration engine 1040 of FIG. 10), based on the depth data and/or the pose data, a respective 3D representation value for each voxel block of the plurality of voxel blocks. In some aspects, the respective 3D representation values are truncated signed distance function (TSDF) values or point cloud values. In some cases, the TSDF values are generated using a deep-learning machine learning system (e.g., a deep-learning neural network) that operates on one or more red, green, blue (RGB) images (or other types of images) of the scene and the pose data.

At block 2006, the computing device (or component thereof) can (e.g., using mesh hysteresis engine 1060) compare each of the respective 3D representation values (e.g., new TSDF values) with a corresponding respective previous 3D representation value (e.g., a previous TSDF value) to estimate a distance difference for each voxel block of the plurality of voxel blocks.

At block 2008, the computing device (or component thereof) can (e.g., using mesh hysteresis engine 1060) identify one or more voxel blocks of the plurality of voxel blocks having a distance difference greater than a distance threshold.

At block 2010, the computing device (or component thereof) can generate (e.g., using the surface extraction engine 1070 of FIG. 10) a 3D mesh based on the identified one or more voxel blocks. In some aspects, the computing device (or component thereof) can generate the 3D mesh based on a marching cube algorithm. For example, as described with respect to FIG. 10, the surface extraction engine 1070 can use a marching cube algorithm (e.g., described in the description of FIG. 12) to extract the surfaces from the block or blocks to generate a 3D mesh representation (e.g., an unsimplified mesh).

At block 2012, the computing device (or component thereof) can generate (e.g., using the mesh simplification engine 1080 of FIG. 10) a simplified 3D mesh based on the generated 3D mesh. In some aspects, to generate the simplified 3D mesh, the computing device (or component thereof) can fuse one or more triangles together within the generated 3D mesh. In some examples, the computing device (or component thereof) can fuse triangles within the generated 3D mesh until a hardware limit is reached based on a number of triangles within the simplified 3D mesh and/or until a threshold compression ratio is reached. In some cases, to generate the simplified 3D mesh, the computing device (or component thereof) can minimize a number of triangles used for the simplified 3D mesh. In some examples, to minimize the number of triangles, the computing device (or component thereof) can remove redundant triangles.

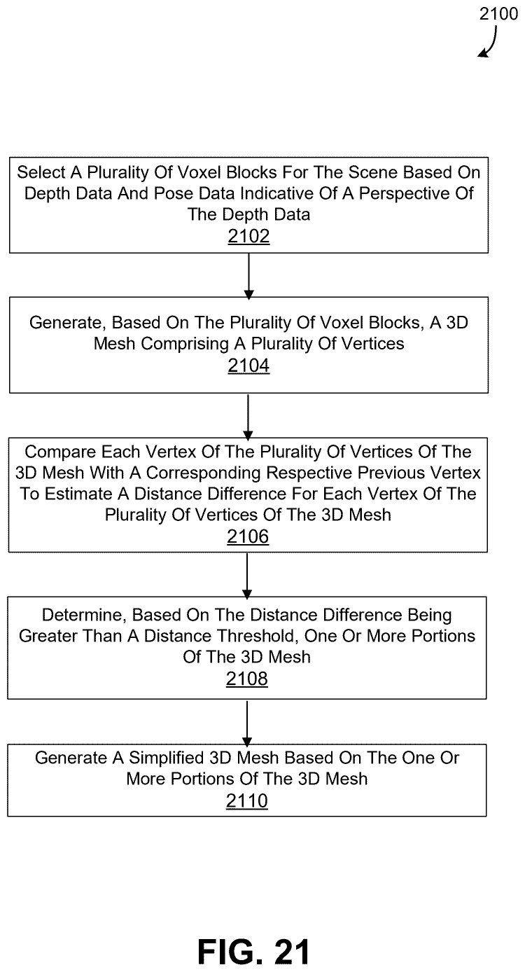

FIG. 21 is a flow chart illustrating an example of a process 2100 for image processing. The process 2100 can be performed by a computing device (e.g., a computing device or computing system 2300 of FIG. 23) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 2100 may be implemented as software components that are executed and run on one or more processors (e.g., processor 2310 of FIG. 23, or other processor(s)). Further, the transmission and reception of signals by the computing device in the process 2100 may be enabled, for example, by one or more antennas and/or one or more transceivers (e.g., wireless transceiver(s)).

At block 2102, the computing device (or component thereof) can select (e.g., using voxel block selection engine 1330 of FIG. 13) a plurality of voxel blocks for the scene based on depth data (e.g., depth data of 2D depth map 1310 of FIG. 13) and pose data (e.g., 6 DoF pose 1320 of FIG. 13) indicative of a perspective of the depth data.

At block 2104, the computing device (or component thereof) can generate (e.g., using surface extraction engine 1370 of FIG. 13), based on the plurality of voxel blocks, a 3D mesh including a plurality of vertices. In some aspects, the computing device (or component thereof) can generate the 3D mesh based on a marching cube algorithm. For example, as described with respect to FIG. 13, the surface extraction engine 1370 can use a marching cube algorithm (e.g., described in the description of FIG. 12) to extract the surfaces from the selected blocks to generate an unsimplified 3D mesh representation, the mesh hysteresis engine 1360 operates on the unsimplified 3D mesh produced by the surface extraction engine 1370.

In some aspects, the computing device (or component thereof) can generate (e.g., using the depth fusion and TSDF integration engine 1340 of FIG. 13), based on the depth data and/or the pose data, a respective 3D representation value for each voxel block of the plurality of voxel blocks. In some cases, the respective 3D representation values are truncated signed distance function (TSDF) values or point cloud values. In some examples, the TSDF values are generated using a deep-learning machine learning system (e.g., a deep-learning neural network) that operates on one or more RGB images (or other types of images) of the scene and the pose data.

At block 2106, the computing device (or component thereof) can compare (e.g., using the mesh hysteresis engine 1360 of FIG. 13) each vertex of the plurality of vertices of the generated 3D mesh with a corresponding respective previous vertex to estimate a distance difference for each vertex of the plurality of vertices of the 3D mesh

At block 2108, the computing device (or component thereof) can identify (e.g., using the mesh hysteresis engine 1360 of FIG. 13) one or more portions of the generated 3D mesh corresponding to vertices of the plurality of vertices having a distance difference greater than a distance threshold.

At block 2110, the computing device (or component thereof) can generate (e.g., using the mesh simplification engine 1380 of FIG. 13) a simplified 3D mesh based on the one or more portions of the generated 3D mesh. In some aspects, to generate the simplified 3D mesh, the computing device (or component thereof) can fuse one or more triangles together within the generated 3D mesh. In some examples, the computing device (or component thereof) can fuse triangles within the generated 3D mesh until a hardware limit is reached based on a number of triangles within the simplified 3D mesh and/or until a threshold compression ratio is reached. In some cases, to generate the simplified 3D mesh, the computing device (or component thereof) can minimize a number of triangles used for the simplified 3D mesh. In some examples, to minimize the number of triangles, the computing device (or component thereof) can remove redundant triangles.

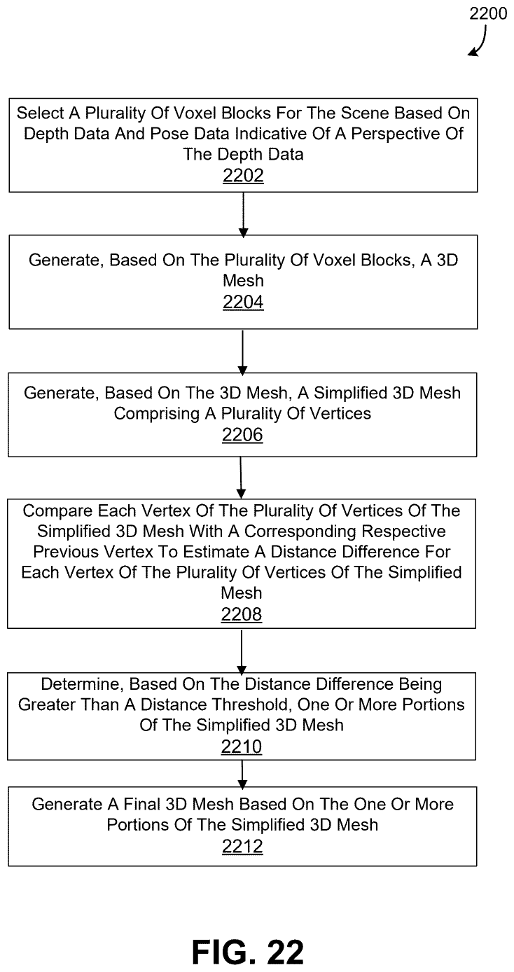

FIG. 22 is a flow chart illustrating an example of a process 2200 for image processing. The process 2200 can be performed by a computing device (e.g., a computing device or computing system 2300 of FIG. 23) or by a component or system (e.g., a chipset, one or more processors central processing units (CPUs), digital signal processors (DSPs), graphics processing units (GPUs), any combination thereof, and/or other type of processor(s), or other component or system) of the computing device. The operations of the process 2200 may be implemented as software components that are executed and run on one or more processors (e.g., processor 2310 of FIG. 23, or other processor(s)). Further, the transmission and reception of signals by the computing device in the process 2200 may be enabled, for example, by one or more antennas and/or one or more transceivers (e.g., wireless transceiver(s)).

At block 2202, the computing device (or component thereof) can select (e.g., using voxel block selection engine 1530 of FIG. 15) a plurality of voxel blocks for the scene based on depth data (e.g., depth data of 2D depth map 1510 of FIG. 15) and pose data (e.g., 6 DoF pose 1520 of FIG. 15) indicative of a perspective of the depth data.

In some aspects, the computing device (or component thereof) can generate (e.g., using the depth fusion and TSDF integration engine 1540 of FIG. 15), based on the depth data and/or the pose data, a respective 3D representation value for each voxel block of the plurality of voxel blocks. In some cases, the respective 3D representation values are truncated signed distance function (TSDF) values or point cloud values. In some examples, the TSDF values are generated using a deep-learning machine learning system (e.g., a deep-learning neural network) that operates on one or more RGB images (or other types of images) of the scene and the pose data.

At block 2204, the computing device (or component thereof) can generate (e.g., using surface extraction engine 1570 of FIG. 15), based on the plurality of voxel blocks, a 3D mesh. In some aspects, generate the 3D mesh based on a marching cube algorithm, as described herein.

At block 2206, the computing device (or component thereof) can generate (e.g., using the mesh simplification engine 1580 of FIG. 15), based on the generated 3D mesh, a simplified 3D mesh including a plurality of vertices. In some aspects, to generate the simplified 3D mesh, the computing device (or component thereof) can fuse one or more triangles together within the generated 3D mesh. In some examples, the computing device (or component thereof) can fuse triangles within the generated 3D mesh until a hardware limit is reached based on a number of triangles within the simplified 3D mesh and/or until a threshold compression ratio is reached. In some cases, to generate the simplified 3D mesh, the computing device (or component thereof) can minimize a number of triangles used for the simplified 3D mesh. In some examples, to minimize the number of triangles, the computing device (or component thereof) can remove redundant triangles.

At block 2208, the computing device (or component thereof) can compare (e.g., using the mesh hysteresis engine 1560 of FIG. 15) each vertex of the plurality of vertices of the simplified 3D mesh with a corresponding respective previous vertex to estimate a distance difference for each vertex of the plurality of vertices of the simplified 3D mesh.

At block 2210, the computing device (or component thereof) can identify (e.g., using the mesh hysteresis engine 1560 of FIG. 15) one or more portions of the simplified 3D mesh corresponding to vertices of the plurality of vertices having a distance difference greater than a distance threshold.

At block 2212, the computing device (or component thereof) can generate a final 3D mesh based on the one or more portions of the simplified 3D mesh.

In some cases, the computing device of process 2000, process 2100, and process 2200 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 2000, process 2100, and process 2200 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 2000, process 2100, and process 2200 are each illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 2000, process 2100, and process 2200 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 23 is a block diagram illustrating an example of a computing system 2300, which may be employed for efficient block-based 3D reconstruction system with mesh hysteresis and simplification. In particular, FIG. 23 illustrates an example of computing system 2300, which can be for example any computing device making up internal computing system, a remote computing system, a camera, or any component thereof in which the components of the system are in communication with each other using connection 2305. Connection 2305 can be a physical connection using a bus, or a direct connection into processor 2310, such as in a chipset architecture. Connection 2305 can also be a virtual connection, networked connection, or logical connection.

In some aspects, computing system 2300 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 2300 includes at least one processing unit (CPU or processor) 2310 and connection 2305 that communicatively couples various system components including system memory 2315, such as read-only memory (ROM) 2320 and random access memory (RAM) 2325 to processor 2310. Computing system 2300 can include a cache 2312 of high-speed memory connected directly with, in close proximity to, or integrated as part of processor 2310.

Processor 2310 can include any general purpose processor and a hardware service or software service, such as services 2332, 2334, and 2336 stored in storage device 2330, configured to control processor 2310 as well as a special-purpose processor where software instructions are incorporated into the actual processor design. Processor 2310 may essentially be a completely self-contained computing system, containing multiple cores or processors, a bus, memory controller, cache, etc. A multi-core processor may be symmetric or asymmetric.

To enable user interaction, computing system 2300 includes an input device 2345, which can represent any number of input mechanisms, such as a microphone for speech, a touch-sensitive screen for gesture or graphical input, keyboard, mouse, motion input, speech, etc. Computing system 2300 can also include output device 2335, which can be one or more of a number of output mechanisms. In some instances, multimodal systems can enable a user to provide multiple types of input/output to communicate with computing system 2300.

Computing system 2300 can include communications interface 2340, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 2340 may also include one or more range sensors (e.g., LiDAR sensors, laser range finders, RF radars, ultrasonic sensors, and infrared (IR) sensors) configured to collect data and provide measurements to processor 2310, whereby processor 2310 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 2340 may also include one or more receivers or transceivers that are used to determine a location of the computing system 2300 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 2330 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 2330 can include software services, servers, services, etc., that when the code that defines such software is executed by the processor 2310, it causes the system to perform a function. In some aspects, a hardware service that performs a particular function can include the software component stored in a computer-readable medium in connection with the necessary hardware components, such as processor 2310, connection 2305, output device 2335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, engines, circuits, and algorithm steps described in connection with the aspects disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, engines, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices.

Any features described as modules, engines, components, etc. may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:
Aspect 1. An apparatus for three-dimensional (3D) reconstruction of a scene, the apparatus comprising: at least one memory; and at least one processor coupled to the at least one memory and configured to: select a plurality of voxel blocks for the scene based on depth data and pose data indicative of a perspective of the depth data; generate, based on at least one of the depth data or the pose data, a respective 3D representation value for each voxel block of the plurality of voxel blocks; compare each of the respective 3D representation values with a corresponding respective previous 3D representation value to estimate a distance difference for each voxel block of the plurality of voxel blocks; identify one or more voxel blocks of the plurality of voxel blocks having a distance difference greater than a distance threshold; generate a 3D mesh based on the identified one or more voxel blocks; and generate a simplified 3D mesh based on the generated 3D mesh.
Aspect 2. The apparatus of Aspect 1, wherein the respective 3D representation values are truncated signed distance function (TSDF) values or point cloud values.
Aspect 3. The apparatus of Aspect 2, wherein the TSDF values are generated based on deep-learning that operates on one or more red, green, blue (RGB) images of the scene and the pose data.
Aspect 4. The apparatus of any of Aspects 1 to 3, wherein the at least one processor is configured to generate the 3D mesh based on a marching cube algorithm.
Aspect 5. The apparatus of any of Aspects 1 to 4, wherein, to generate the simplified 3D mesh, the at least one processor is configured to fuse one or more triangles together within the generated 3D mesh.
Aspect 6. The apparatus of Aspect 5, wherein, to generate the simplified 3D mesh, the at least one processor is further configured to minimize a number of triangles used for the simplified 3D mesh.
Aspect 7. The apparatus of Aspect 6, wherein, to minimize the number of triangles, the at least one processor is configured to remove redundant triangles.
Aspect 8. The apparatus of any of Aspects 5 to 7, wherein the at least one processor is configured to fuse triangles within the generated 3D mesh until a hardware limit is reached based on a number of triangles within the simplified 3D mesh.
Aspect 9. The apparatus of any of Aspects 5 to 7, wherein the at least one processor is configured to fuse triangles within the generated 3D mesh until a threshold compression ratio is reached.
Aspect 10. An apparatus for three-dimensional (3D) reconstruction of a scene, the apparatus comprising: at least one memory; and at least one processor coupled to the at least one memory and configured to: select a plurality of voxel blocks for the scene based on depth data and pose data indicative of a perspective of the depth data; generate, based on the plurality of voxel blocks, a 3D mesh comprising a plurality of vertices; compare each vertex of the plurality of vertices of the generated 3D mesh with a corresponding respective previous vertex to estimate a distance difference for each vertex of the plurality of vertices of the 3D mesh; identify one or more portions of the generated 3D mesh corresponding to vertices of the plurality of vertices having a distance difference greater than a distance threshold; and generate a simplified 3D mesh based on the one or more portions of the generated 3D mesh.
Aspect 11. The apparatus of Aspect 10, wherein the at least one processor is configured to generate the 3D mesh based on a marching cube algorithm.
Aspect 12. The apparatus of any of Aspects 10 or 11, wherein, to generate the simplified 3D mesh, the at least one processor is configured to fuse one or more triangles together within the generated 3D mesh.
Aspect 13. The apparatus of Aspect 12, wherein, to generate the simplified 3D mesh, the at least one processor is further configured to minimize a number of triangles used for the simplified 3D mesh.
Aspect 14. The apparatus of Aspect 13, wherein, to minimize the number of triangles, the at least one processor is configured to remove redundant triangles.
Aspect 15. The apparatus of any of Aspects 12 to 14, wherein the at least one processor is configured to fuse triangles within the generated 3D mesh until a hardware limit is reached based on a number of triangles within the simplified 3D mesh.
Aspect 16. The apparatus of any of Aspects 12 to 15, wherein the at least one processor is configured to fuse triangles within the generated 3D mesh until a threshold compression ratio is reached.
Aspect 17. An apparatus for three-dimensional (3D) reconstruction of a scene, the apparatus comprising: at least one memory; and at least one processor coupled to the at least one memory and configured to: select a plurality of voxel blocks for the scene based on depth data and pose data indicative of a perspective of the depth data; generate, based on the plurality of voxel blocks, a 3D mesh; generate, based on the generated 3D mesh, a simplified 3D mesh comprising a plurality of vertices; compare each vertex of the plurality of vertices of the simplified 3D mesh with a corresponding respective previous vertex to estimate a distance difference for each vertex of the plurality of vertices of the simplified 3D mesh; identify one or more portions of the simplified 3D mesh corresponding to vertices of the plurality of vertices having a distance difference greater than a distance threshold; and generate a final 3D mesh based on the one or more portions of the simplified 3D mesh.
Aspect 18. The apparatus of Aspect 17, wherein the at least one processor is configured to generate the 3D mesh based on a marching cube algorithm.
Aspect 19. The apparatus of any of Aspects 17 or 18, wherein, to generate the simplified 3D mesh, the at least one processor is configured to fuse one or more triangles together within the generated 3D mesh.
Aspect 20. The apparatus of Aspect 19, wherein, to generate the simplified 3D mesh, the at least one processor is further configured to minimize a number of triangles used for the simplified 3D mesh.
Aspect 21. The apparatus of Aspect 20, wherein, to minimize the number of triangles, the at least one processor is configured to remove redundant triangles.
Aspect 22. The apparatus of any of Aspects 19 to 21, wherein the at least one processor is configured to fuse triangles within the generated 3D mesh until a hardware limit is reached based on a number of triangles within the simplified 3D mesh.
Aspect 23. The apparatus of any of Aspects 19 to 22, wherein the at least one processor is configured to fuse triangles within the generated 3D mesh until a threshold compression ratio is reached.
Aspect 24. A method for three-dimensional (3D) reconstruction of a scene, the method comprising: selecting a plurality of voxel blocks for the scene based on depth data and pose data indicative of a perspective of the depth data; generating, based on at least one of the depth data or the pose data, a respective 3D representation value for each voxel block of the plurality of voxel blocks; comparing each of the respective 3D representation values with a corresponding respective previous 3D representation value to estimate a distance difference for each voxel block of the plurality of voxel blocks; identifying one or more voxel blocks of the plurality of voxel blocks having a distance difference greater than a distance threshold; generating a 3D mesh based on the identified one or more voxel blocks; and generating a simplified 3D mesh based on the generated 3D mesh.
Aspect 25. The method of Aspect 24, wherein the respective 3D representation values are truncated signed distance function (TSDF) values or point cloud values.
Aspect 26. The method of Aspect 25, wherein the TSDF values are generated based on deep-learning that operates on one or more red, green, blue (RGB) images of the scene and the pose data.
Aspect 27. The method of any of Aspects 24 to 26, wherein the 3D mesh is generated based on a marching cube algorithm.
Aspect 28. The method of any of Aspects 24 to 27, wherein the simplified 3D mesh is generated based on fusing one or more triangles together within the generated 3D mesh.
Aspect 29. The method of Aspect 28, wherein the simplified 3D mesh is generated further based on minimizing a number of triangles used for the simplified 3D mesh.
Aspect 30. The method of Aspect 29, wherein minimizing the number of triangles comprises removing redundant triangles.
Aspect 31. The method of any of Aspects 28 to 30, further comprising fusing triangles within the generated 3D mesh until a hardware limit is reached based on a number of triangles within the simplified 3D mesh.
Aspect 32. The method of any of Aspects 28 to 31, further comprising fusing triangles within the generated 3D mesh until a threshold compression ratio is reached.
Aspect 33. A method for three-dimensional (3D) reconstruction of a scene, the method comprising: selecting a plurality of voxel blocks for the scene based on depth data and pose data indicative of a perspective of the depth data; generating, based on the plurality of voxel blocks, a 3D mesh comprising a plurality of vertices; comparing each vertex of the plurality of vertices of the generated 3D mesh with a corresponding respective previous vertex to estimate a distance difference for each vertex of the plurality of vertices of the 3D mesh; identifying one or more portions of the generated 3D mesh corresponding to vertices of the plurality of vertices having a distance difference greater than a distance threshold; and generating a simplified 3D mesh based on the one or more portions of the generated 3D mesh.
Aspect 34. The method of Aspect 33, wherein the 3D mesh is generated based on a marching cube algorithm.
Aspect 35. The method of any of Aspects 33 or 34, wherein the simplified 3D mesh is generated based on fusing one or more triangles together within the generated 3D mesh.
Aspect 36. The method of Aspect 35, wherein the simplified 3D mesh is generated further based on minimizing a number of triangles used for the simplified 3D mesh.
Aspect 37. The method of Aspect 36, wherein minimizing the number of triangles comprises removing redundant triangles.
Aspect 38. The method of any of Aspects 35 to 37, further comprising fusing triangles within the generated 3D mesh until a hardware limit is reached based on a number of triangles within the simplified 3D mesh.
Aspect 39. The method of any of Aspects 35 to 38, further comprising fusing triangles within the generated 3D mesh until a threshold compression ratio is reached.
Aspect 40. A method for three-dimensional (3D) reconstruction of a scene, the method comprising: selecting a plurality of voxel blocks for the scene based on depth data and pose data indicative of a perspective of the depth data; generating, based on the plurality of voxel blocks, a 3D mesh; generating, based on the generated 3D mesh, a simplified 3D mesh comprising a plurality of vertices; comparing each vertex of the plurality of vertices of the simplified 3D mesh with a corresponding respective previous vertex to estimate a distance difference for each vertex of the plurality of vertices of the simplified 3D mesh; identifying one or more portions of the simplified 3D mesh corresponding to vertices of the plurality of vertices having a distance difference greater than a distance threshold; and generating a final 3D mesh based on the one or more portions of the simplified 3D mesh.
Aspect 41. The method of Aspect 40, wherein the 3D mesh is generated based on a marching cube algorithm.
Aspect 42. The method of any of Aspects 40 or 41, wherein the simplified 3D mesh is generated based on fusing one or more triangles together within the generated 3D mesh.
Aspect 43. The method of Aspect 42, wherein the simplified 3D mesh is generated further based on minimizing a number of triangles used for the simplified 3D mesh.
Aspect 44. The method of Aspect 43, wherein minimizing the number of triangles comprises removing redundant triangles.
Aspect 45. The method of any of Aspects 42 to 44, further comprising fusing triangles within the generated 3D mesh until a hardware limit is reached based on a number of triangles within the simplified 3D mesh.
Aspect 46. The method of any of Aspects 42 to 45, further comprising fusing triangles within the generated 3D mesh until a threshold compression ratio is reached.
Aspect 47. A non-transitory computer-readable medium having stored thereon instructions that, when executed by at least one processor, cause the at least one processor to perform operations according to any of Aspects 24 to 32.
Aspect 48. An apparatus for three-dimensional (3D) reconstruction of a scene, the apparatus including one or more means for performing operations according to any of Aspects 24 to 32.
Aspect 49. A non-transitory computer-readable medium having stored thereon instructions that, when executed by at least one processor, cause the at least one processor to perform operations according to any of Aspects 33 to 39.
Aspect 50. An apparatus for 3D reconstruction of a scene, the apparatus including one or more means for performing operations according to any of Aspects 33 to 39.
Aspect 51. A non-transitory computer-readable medium having stored thereon instructions that, when executed by at least one processor, cause the at least one processor to perform operations according to any of Aspects 40 to 46.
Aspect 52. An apparatus for 3D reconstruction of a scene, the apparatus including one or more means for performing operations according to any of Aspects 40 to 46.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for three-dimensional (3D) reconstruction of a scene, the apparatus comprising:
at least one memory; and
at least one processor coupled to the at least one memory and configured to:
select a plurality of voxel blocks for the scene based on depth data and pose data indicative of a perspective of the depth data;
generate, based on at least one of the depth data or the pose data, a respective 3D representation value for each voxel block of the plurality of voxel blocks;
compare each of the respective 3D representation values with a corresponding respective previous 3D representation value to estimate a distance difference for each voxel block of the plurality of voxel blocks;
identify one or more voxel blocks of the plurality of voxel blocks having a distance difference greater than a distance threshold;
generate a 3D mesh based on the identified one or more voxel blocks; and
generate a simplified 3D mesh based on the generated 3D mesh.

2. The apparatus of claim 1, wherein the respective 3D representation values are truncated signed distance function (TSDF) values or point cloud values.

3. The apparatus of claim 2, wherein the TSDF values are generated based on deep-learning that operates on one or more red, green, blue (RGB) images of the scene and the pose data.

4. The apparatus of claim 1, wherein the at least one processor is configured to generate the 3D mesh based on a marching cube algorithm.

5. The apparatus of claim 1, wherein, to generate the simplified 3D mesh, the at least one processor is configured to fuse one or more triangles together within the generated 3D mesh.

6. The apparatus of claim 5, wherein, to generate the simplified 3D mesh, the at least one processor is further configured to minimize a number of triangles used for the simplified 3D mesh.

7. The apparatus of claim 6, wherein, to minimize the number of triangles, the at least one processor is configured to remove redundant triangles.

8. The apparatus of claim 5, wherein the at least one processor is configured to fuse triangles within the generated 3D mesh until a hardware limit is reached based on a number of triangles within the simplified 3D mesh.

9. The apparatus of claim 5, wherein the at least one processor is configured to fuse triangles within the generated 3D mesh until a threshold compression ratio is reached.

10. An apparatus for three-dimensional (3D) reconstruction of a scene, the apparatus comprising:
at least one memory; and
at least one processor coupled to the at least one memory and configured to:
select a plurality of voxel blocks for the scene based on depth data and pose data indicative of a perspective of the depth data;
generate, based on the plurality of voxel blocks, a 3D mesh comprising a plurality of vertices;
compare each vertex of the plurality of vertices of the generated 3D mesh with a corresponding respective previous vertex to estimate a distance difference for each vertex of the plurality of vertices of the 3D mesh;
identify one or more portions of the generated 3D mesh corresponding to vertices of the plurality of vertices having a distance difference greater than a distance threshold; and
generate a simplified 3D mesh based on the one or more portions of the generated 3D mesh.

11. The apparatus of claim 10, wherein the at least one processor is configured to generate the 3D mesh based on a marching cube algorithm.

12. The apparatus of claim 10, wherein, to generate the simplified 3D mesh, the at least one processor is configured to fuse one or more triangles together within the generated 3D mesh.

13. The apparatus of claim 12, wherein, to generate the simplified 3D mesh, the at least one processor is further configured to minimize a number of triangles used for the simplified 3D mesh.

14. The apparatus of claim 13, wherein, to minimize the number of triangles, the at least one processor is configured to remove redundant triangles.

15. The apparatus of claim 12, wherein the at least one processor is configured to fuse triangles within the generated 3D mesh until a hardware limit is reached based on a number of triangles within the simplified 3D mesh.

16. The apparatus of claim 12, wherein the at least one processor is configured to fuse triangles within the generated 3D mesh until a threshold compression ratio is reached.

17. An apparatus for three-dimensional (3D) reconstruction of a scene, the apparatus comprising:
at least one memory; and
at least one processor coupled to the at least one memory and configured to:
select a plurality of voxel blocks for the scene based on depth data and pose data indicative of a perspective of the depth data;
generate, based on the plurality of voxel blocks, a 3D mesh;
generate, based on the generated 3D mesh, a simplified 3D mesh comprising a plurality of vertices;
compare each vertex of the plurality of vertices of the simplified 3D mesh with a corresponding respective previous vertex to estimate a distance difference for each vertex of the plurality of vertices of the simplified 3D mesh;
identify one or more portions of the simplified 3D mesh corresponding to vertices of the plurality of vertices having a distance difference greater than a distance threshold; and
generate a final 3D mesh based on the one or more portions of the simplified 3D mesh.

18. The apparatus of claim 17, wherein the at least one processor is configured to generate the 3D mesh based on a marching cube algorithm.

19. The apparatus of claim 17, wherein, to generate the simplified 3D mesh, the at least one processor is configured to fuse one or more triangles together within the generated 3D mesh.

20. The apparatus of claim 19, wherein, to generate the simplified 3D mesh, the at least one processor is further configured to minimize a number of triangles used for the simplified 3D mesh.

21. The apparatus of claim 20, wherein, to minimize the number of triangles, the at least one processor is configured to remove redundant triangles.

22. The apparatus of claim 19, wherein the at least one processor is configured to fuse triangles within the generated 3D mesh until a hardware limit is reached based on a number of triangles within the simplified 3D mesh.

23. The apparatus of claim 19, wherein the at least one processor is configured to fuse triangles within the generated 3D mesh until a threshold compression ratio is reached.

24. A method for three-dimensional (3D) reconstruction of a scene, the method comprising:
selecting a plurality of voxel blocks for the scene based on depth data and pose data indicative of a perspective of the depth data;
generating, based on at least one of the depth data or the pose data, a respective 3D representation value for each voxel block of the plurality of voxel blocks;
comparing each of the respective 3D representation values with a corresponding respective previous 3D representation value to estimate a distance difference for each voxel block of the plurality of voxel blocks;
identifying one or more voxel blocks of the plurality of voxel blocks having a distance difference greater than a distance threshold;
generating a 3D mesh based on the identified one or more voxel blocks; and
generating a simplified 3D mesh based on the generated 3D mesh.

25. The method of claim 24, wherein the respective 3D representation values are truncated signed distance function (TSDF) values or point cloud values.

26. The method of claim 25, wherein the TSDF values are generated based on deep-learning that operates on one or more red, green, blue (RGB) images of the scene and the pose data.

27. The method of claim 24, wherein the 3D mesh is generated based on a marching cube algorithm.

28. The method of claim 24, wherein the simplified 3D mesh is generated based on fusing one or more triangles together within the generated 3D mesh.

29. The method of claim 28, wherein the simplified 3D mesh is generated further based on minimizing a number of triangles used for the simplified 3D mesh.

30. The method of claim 28, further comprising fusing triangles within the generated 3D mesh until a hardware limit is reached based on a number of triangles within the simplified 3D mesh.
